(19) United States
(12) Patent Application Publication
(10) Pub. No.: US 2013/0008332 A1
(43) Pub. Date: Jan. 10, 2013

(54) ANTI-COUNTERFEIT PRINTED PACKAGING MATERIAL

(76) Inventors: Ajith S. Nair, Pune (IN); Praful Naik, Pune (IN); Somenath Salien Mukherjee, Pune (IN); Sameer Suresh Apte, Pune (IN); Manish Anil Mudkavi, Housing Society (IN); Santosh Shankarrao Karne, Pune (IN)

(21) Appl. No.: 13/511,505

(22) PCT Filed: Nov. 23, 2010
(86) PCT No.: PCT/IN2010/000760

§ 371 Date: Sep. 21, 2012

(30) Foreign Application Priority Data
Nov. 24, 2009 (IN) 2714/MUM/2009

(51) Int. Cl. B41F 33/00; B42D 15/00

(52) U.S. Cl. 101/483; 283/79

(57) ABSTRACT

The present invention provides a packaging material comprising a plurality of layers, said material having discernible indicia for authentication characterized by the presence of at least one predetermined anti-counterfeit feature at, at least one predetermined location in at least one predetermined visible layer. Also, provided in accordance with the present invention is a process for manufacturing said packaging material.

### FIELD OF THE INVENTION

The present invention relates to printed packaging foils, films and laminates.

More particularly, the present invention relates to printed packaging foils, films and laminates having discernible identity for authentication and anti-counterfeit measures which will act as a protective identification and authentication for convenience packs such as blister and strip packs.

### BACKGROUND OF THE INVENTION

Today, a significant fraction of healthcare products and variety of other products including consumable products and non edible products are packed in convenience packs such as blister and strip packs. Amongst many other advantages, blister and strip packaging offers convenience in terms of portability and also helps to protect a packaged drug's quality, efficacy and safety throughout its shelf life.

Convenience packs such as blister and strip packs have proven to be a highly effective and successful packaging form for the pharmaceutical industry. Not only do they instill confidence regarding the quality, safety and efficacy of a product, but also they also provide the manufacturer with a surface comprising of a base or backing material and lidding material upon which information may be provided to the consumer. Blister base material can be formed by thermoforming or cold forming process.

Counterfeiting is a severe problem for all industries including the pharmaceutical industry. Legitimate businesses are losing millions due to counterfeit activity. Counterfeiting is the fastest growing crime in the world. Studies show that consumers would prefer to buy products that are in tamper evident authenticated packaging so as to reduce the chance of buying imitation products.

However, with the growing counterfeiting problem that the pharmaceutical industry has to tackle, every leading brand is prone to be attacked by unscrupulous individuals. Counterfeiters not only copy the leading brand, but can also permanently damage its reputation. It is the responsibility of the manufacturer or brand owner to ensure that a genuine unadulterated product reaches the consumer.

Counterfeiting and piracy are terms used to describe a range of illicit activities linked to intellectual property rights (IPR) infringement. Counterfeiters and pirates target products where profit margins are high, taking into account the risks of detection, the potential penalties, the size of the markets that could be exploited and the technological and logistical challenges in producing and distributing products.

Counterfeit medicines are deliberately and fraudulently mislabeled with respect to identity or source: their quality is unpredictable as they may contain the wrong amount of active ingredients, wrong ingredients or no active ingredients. In all cases counterfeit medicines are manufactured in clandestine laboratories with no possibility of control. Counterfeiting of medicines occurs both with branded and generic products. Counterfeiting has also been discovered in relation to medical devices. It has been found that counterfeiters copy or imitate existing products, but they also manufacture products which they have invented, and are not normally available.

Counterfeit medicines represent an enormous public health challenge. Anyone, anywhere in the world, can come across medicines seemingly packaged in the right way but which do not contain the correct ingredients and, in the worst-case scenario, may be filled with highly toxic substances. In some countries, this is a rare occurrence, in others, it is an everyday reality.

Counterfeit medicines range from random mixtures of harmful toxic substances to inactive, useless preparations. Occasionally, there can be fakes that do contain the declared active ingredient and look so similar to the genuine product to deceive health professionals and patients. In all cases counterfeits content is unreliable, their source is unknown and, by definition, always illegal.

Any kind of product can be and has been counterfeited: expensive lifestyle and anticancer medicines, antibiotics, medicines for hypertension and cholesterol-lowering medicines, hormones, steroids and inexpensive generic versions of simple pain killers and antihistamines, blood glucose test strips and condoms. In developing countries the most disturbing issue is the common availability of counterfeited medicines for the treatment of life-threatening conditions such as malaria, tuberculosis and HIV and AIDS.

The use of substandard or counterfeit medicines can lead to therapeutic failure or drug resistance. In some cases, it can lead to death.

Convenience packs such as blister and strip packs, which are prone to counterfeiting, appears to be losing its ‘sheen’ due to lack of uniqueness, in ensuring the authenticity and genuineness of the drug. Additionally, the printing technologies presently employed are conventional and hence makes it very easy for an imitator to get a similar printed lidding material without much effort. Secondly, the print inputs do not encompass a blend of technologies which can enable a considerable level of deterrence for an imitator to wrongfully duplicate an original product. Therefore, it can be a viable proposition if printing technologies evolves such that it is impossible for a counterfeiter to duplicate.

### OBJECTS OF THE INVENTION

It is an object of the present invention to provide a packaging material providing discernible identity for authentication and anti-counterfeit measures which acts as a protective authentication for convenience packs such as blister and strip packs used for packaging pharmaceutical, healthcare, medical products, edible products and non-edible products.

Another object of the present invention is to provide a packaging material which is embedded with unique anti-counterfeit print features.

Yet another object of the present invention is to provide a packaging material with a discernible identity for authentication and anti-counterfeit measures which is non-reproducible using any other conventional and standard printing technologies.

Yet another object of the present invention is to provide a packaging material with a discernible identity for authentication and anti-counterfeit measures which does not contaminate the packaged product.

Still another object of this invention is to provide a packaging material with a discernible identity for authentication and anti-counterfeit measures which act as a protective authentication for convenience packs such as blister and strip packs and by which a lay person can easily identify the authentic product at a display counter and distinguish it from a fake.

Still another object of the present invention is to provide a process for manufacturing of a packaging material with a discernible identity for authentication and anti-counterfeit measures.

### SUMMARY OF THE INVENTION

In accordance with a first aspect, the present invention provides a packaging material comprising a plurality of layers, said material with discernible indicia for authentication characterized by the presence of at least one predetermined anti-counterfeit feature at, at least one predetermined location in at least one predetermined visible layer.

Typically, the anti-counterfeit feature is in a form selected from the group consisting of a geometric pattern, a non-geometric pattern, a graphic matter, miniature size textual matter, ink which becomes visible in U.V. light, ink which becomes visible in Infra Red, a color scheme, nano-particle based signature marker, machine readable marker and a combination thereof

Typically, the feature is visible to the naked eye.

Alternatively, the feature is selectively visible in a predetermined manner.

Still alternatively, the feature is recognizable under predetermined wavelength spectrum of ultra-violet light.

In accordance with one of the embodiments of the present invention, the feature is in a machine readable form.

In accordance with one of the embodiments of the present invention, the feature is further characterized by its concentration at said predetermined location.

Typically, the visible layer is a metallic layer with a thickness of about 5 microns to about 200 microns.

In accordance with one of the embodiments of the present invention, the visible layer is an aluminum foil with a thickness of about 15 microns to about 80 microns.

Typically, the visible layer is selected from the group consisting of thermoformable polymer film, thermoformable polymer laminate, heat sealable BOPP film, heat sealable BOPP laminate, heat seal lacquer coated glassine paper, aluminum based cold formable foil, aluminum based laminated strip foil and heat seal coated aluminum foil.

Typically, the packaging material is selected from the group consisting of a thermoformed blister containing material and a cold formed blister containing material.

In accordance with one of the embodiments of the present invention, the packaging material of the present invention, complies with the requirements for packaging of pharmaceuticals and food-grade items.

In a second aspect of the present invention there is provided a process for manufacture of a packaging material; said process comprising the following steps:
selecting an artwork input to be used in printing of a substrate;
selecting a substrate;
creating a scheme for incorporation of a predetermined anti-counterfeit feature on the substrate;
making a print plan with a set of predetermined print parameters using the scheme;
storing the scheme and the print plan in a database;
incorporating the feature on the substrate by a combination of print means and non-print means, in a sequential manner, using said scheme and print plan to obtain a printed substrate with discernible indicia for authentication; and
preparing the packaging material using the printed substrate as one of its visible layer.

Typically, the anti-counterfeit feature is in a form selected from the group consisting of a geometric pattern, a non-geometric pattern, a graphic matter, miniature size textual matter, ink which becomes visible in U.V. light, a color scheme, nano-particle based signature marker, machine readable marker and a combination thereof.

In accordance with one of the embodiments of the present invention, the feature is incorporated is incorporated on the substrate by print means with a predetermined concentration at a predetermined location.

Typically, the scheme comprises at least one predetermined parameter selected from the group consisting of shape, size, color-shade and location of the feature in the packaging material.

Typically, the print parameter is at least one selected from the group consisting of configuration of the anilox printer ranging between 70 to 340 lines per centimeter, speed within a range of about 60 meters per minute to about 350 meters per minute, the drying temperature between cylinders within a range of about 80° C. to about 130° C.; the drying temperature in tunnel within a range of about 120° C. to 160° C.; the tension on the rollers ranging between 120 to about 300 N/sq.m; plate pressure in the range of about 30 to 150 microns and the temperature of central impression drum ranging between 20 to 35° C.

Typically, the print means is a flexographic printing machine and the non-print means is at least one selected from the group consisting of embossing means, coating means and lacquering means.

Typically, the substrate is selected from the group consisting of thermoformable polymer film, thermoformable polymer laminate, heat sealable BOPP film, heat sealable BOPP laminate, heat seal lacquer coated glassine paper, aluminum based cold formable foil, aluminum based laminated strip foil and heat seal coated aluminum foil.

### DESCRIPTION OF THE INVENTION

In accordance with the present invention there is provided a printed packaging material with discernible identity for authentication and anti-counterfeit measures which act as a protective authentication for convenience packs such as blister and strip packs used for packaging pharmaceutical, healthcare, medical products, edible products and non-edible products.

The packaging material in accordance with the present invention having discernible indicia for authentication comprises a plurality layers. At least one of the predetermined visible layers in the packaging material is characterized by the presence of at least one predetermined anti-counterfeit feature at, at least one predetermined location.

The extent of anti-counterfeit protection required for each of the product varies in each case. The extent of ant-counterfeit protection desired for every product depends on several factors which include the level of sophistication involved in the manufacture of the product, type and nature of market/territory in which the product is to be sold, volume of the sales for that product, revenues accrued from the sale of the product etc.

The packaging material in accordance with the present invention offers flexibility in customizing the extent of anti-counterfeit protection for a given product. Depending on the requirement, the packaging material of the present invention may include a single anti-counterfeit feature or it may include a multiple number of ant-counterfeit features.

In accordance with one of the embodiments of the present invention, the packaging material of the present invention with discernible indicia for authentication comprises a single visible layer with a single anti-counterfeit feature.

In accordance with one of the embodiments of the present invention, the packaging material of the present invention comprises plurality of visible layers each comprising a single anti-counterfeit feature.

In accordance with one embodiment of the present invention, the anti-counterfeit feature is physical in nature and is selected from the group consisting of a geometric pattern, a non-geometric pattern, a graphic matter, miniature size textual matter and an embossed pattern. Typically, the geometric pattern is at least one selected from a group consisting of diamond pattern, a broken glass pattern, a rainbow pattern, a dot pattern, a square pattern, a honey comb pattern, a flower pattern, a triangular pattern, a wavy line pattern, a star burst pattern; a circular pattern and a striation pattern.

In accordance with another embodiment of the present invention, the anti-counterfeit feature is incorporated in the material by introduction of a chemical; said chemical is selected from the group consisting of an ink that becomes visible in U.V. light, ink which becomes visible in Infra Red, a color scheme, nano-particle based signature marker and a machine readable marker.

In accordance with still another embodiment of the present invention, the anti-counterfeit feature is a combination of the features incorporated in the material by both a physical modification and the incorporation of predetermined chemicals which include U.V. light, a color scheme, nano-particle based signature marker and a machine readable marker.

In accordance with one of the embodiments of the present invention, the anti-counterfeit feature incorporated in the packaging material of the present invention is further characterized by its concentration at a predetermined location.

In accordance with one embodiment, the anti-counterfeit feature is feature is selectively visible to the naked eye. In such case, it is very easy for the end customer or the supply chain personnel to detect the authenticity by just visual inspection. In accordance with another embodiment of the present invention, the anti-counterfeit feature is a blend of distinct and discernable features which are recognizable by both naked eye and under high magnification.

In accordance with another embodiment of the present invention, the distinct and discernable anti-counterfeit feature in the packaging material of the present invention is recognizable under predetermined wavelength spectrum of ultra-violet light.

In accordance with a further embodiment of the present invention, the distinct and discernable features anti-counterfeit feature in the packaging material of the present invention is in a machine readable form.

In accordance with a still further embodiment of the present invention, the visible layer is a metallic layer with a thickness of about 5 microns to about 200 microns. In accordance with another embodiment of the present invention, the visible layer is an aluminum foil with a thickness of about 15 microns to about 80 microns.

The predetermined visible layer characterized by the presence of at least one anti-counterfeit feature in the packaging material of the present invention is typically selected from the group consisting of thermoformable polymer film, thermoformable polymer laminate, heat sealable BOPP film, heat sealable BOPP laminate, heat seal lacquer coated glassine paper, aluminum based cold formable foil, aluminum based laminated strip foil and heat seal coated aluminum foil.

In accordance with one of the embodiments of the present invention, the packaging material of the present invention is a thermoformed blister containing material. In accordance with still another embodiment of the present invention the packaging material of the present invention is a cold formed blister containing material.

In accordance with one of the embodiments of this invention, the packaging material in accordance with the present invention is an aluminum foil based printed packaging foils, films or a laminate which includes a polymeric coating film or laminate which has at least one property from a group of properties consisting of moisture barrier, oxygen barrier, gas barrier, or vapor barrier properties. These barrier coatings ensure no micro crack/pinholes in the lidding foil.

The packaging material in accordance with the present invention is suitable for packaging pharmaceutical, healthcare, medical products, edible products and non-edible products. In one specific embodiment of the present invention, the packaging material of the present invention complies complies with the requirements for packaging of pharmaceuticals and food-grade items.

In a second aspect, the present invention provides a process for the preparation of packaging material having discernible indicia for authentication.

The process for preparation of the packaging material of the present invention begins with the selection of art-work which is to be incorporated on a substrate. Typically, the artwork comprises different type of matters which includes a text, a graphic, and an image. A substrate for the preparation of the predetermined visible layer is selected. Typically, the substrate is selected from the group consisting of thermoformable polymer film, thermoformable polymer laminate, heat sealable BOPP film, heat sealable BOPP laminate, heat seal lacquer coated glassine paper, aluminum based cold formable foil, aluminum based laminated strip foil and heat seal coated aluminum foil.

The selected art-work input is examined and depending on the requirements of the client, the anti-counterfeit features to be incorporated are indentified. Designs are made for identified anti-counterfeit features and the art-work inputs are modified. The designers calibrate the designs for the Dot Gain so as to give the required appearances in Half Tones & other specialized visual appeals.

The locations at which the anti-counterfeit features are to be incorporated are determined and a scheme for incorporation of the anti-counterfeit feature is created. Typically, the scheme comprises the details of at least one predetermined parameter selected from the group consisting of shape, size, color-shade and location of the feature in the packaging material and particular concentration of the marker which is to be incorporated.

The scheme is used for making a print plan. Typically, a print plan is made with a set of predetermined print parameters which are selected from the group consisting of configuration of the anilox printer ranging between 70 to 340 lines per centimeter, speed within a range of about 60 meters per minute to about 350 meters per minute, the drying temperature between cylinders within a range of about 80° C. to about 130° C.; the drying temperature in tunnel within a range of about 120° C. to 160° C.; the tension on the rollers ranging between 120 to about 300 N/sq.m; and the temperature of central impression drum ranging between 20 to 35° C.

The scheme and the print plan are securely stored in a database with unique reference number. This stored data is kept highly confidential and it is but impossible for anybody to reproduce the printed matter by referral to the printed substrate without having access to the scheme of incorporation of the discernible features along with the colors, the color separation scheme, location of the UV based ink & KT markers with their concentration and the anilox configuration used for generating the print using any conventional print technology including flexographic printing technology. These files are specially maintained in the design studios under password protection and the relevant parts are maintained at different locations.

A Color Proofing System produces high resolution color proofs which simulates commercial print quality and makes it possible to predict the final printing result in a pre-press stage. In accordance with one of the embodiments of the present invention, the proofing is carried out by using a plate making system. A plate making system uses a proprietary dry thermal process, wherein the images on the plates are formed by using dry thermal mass transfer technology wherein prior to developing the plate the plate material is back-exposed and main-exposed in a typical exposing unit.

This is a standalone unit which comprises of an Exposing and a Developing System and it provides facility to make plates without using any solvents. Therefore, the method step of curing the plates is obviated. This in turn reduces the turn around time. The plates are exposed with the help of matt negatives and then developed in special developing conditions. The plates are developed with the help of Infra Red heaters and the non-image area gets washed out with the help of woven fabric material (TYVEK).

The negatives have the same image which as in the artwork and the same is exposed on the plate for final printing. Each color requires a separate negative e.g. 3 color designs requires (3 negatives) which when exposed make 3 plates. In case of graphics images, multi-screening facility is used while making the negatives. This makes it impossible to copy the image. On the other hand if the image is in the form of a text then microlines, micro text, shadow effect and UV ink printing is employed. The UV ink print can only be observed in the UV light. The KT nano-markers are seen only through scanners having the specific imaging technology which employs polarized light at certain wavelengths. The micro text and micro lines are seen through special graphic lens.

In accordance with one of the embodiments of the invention, the master-proof is prepared in the form of a shade card by employing a digital cromalin proofing system. The digital cromalin system is a ‘drop-on-demand’ inkjet proofer that comprises 8 color cartridges. It is a standalone printing unit with a Raster Image Process with a very high degree of precision. It can be used for printing on any flexible substrate. It has an in-built spectrophotometer installed inside which enables to measure the color density and prints with calibration.

The digital cromalin system has inbuilt pantone library and it also works on the mixing of pantone reference shades plus process colors i.e Cyan, Magenta Yellow, and Black.(K). Because of this, all shades in CMYK and majority of the Pantone shades can be achieved with the digital cromalin system. Furthermore, it also facilitates the printing of spot colors of pantone as well as Halftone images and also the combinations thereof. The digital cromalin system enables print on any flexible substrate. Two types of flexible Films are used, IFM and IFG. The former one is used for matt finish while the latter one is used for gloss finish. The digital cromalin system also has an internal drum on which the IFM/IFG gets rolled with the help of grippers which hold the substrate for printing. There are 8 heads which facilitate printing the image when the drum is moving. Calibration strip is printed on all prints for future reference.

The flexible film (IFG/IFM) after printing is transferred on Transfer Sheet (TS) by lamination process. The transfer sheet in turn is transferred by lamination on the required substrate (foil, paper etc) by lamination.

This helps in matching the colors as per the pantone and the process and gives a color ready reference to match the inks on the press (machine). This helps to give the exact color on the required substrate as the same color looks different on different substrates.

After proofing, the method step of incorporating the feature—on the substrate in accordance with the process of the present invention is carried out by a combination of print means and non-print means, in a sequential manner, using said scheme and print plan to obtain a printed substrate with discernible indicia for authentication.

Flexo graphic plates are made after the proofing process by exposing Photo Polymer Plates under UV Light and developing the same by removal of the portion not exposed to the light in a solvent free environment.

The plate exposure timing depends on the features incorporated in the plate and varies from 5 to 10 mins from Rear Exposure followed by Front Exposure whose timings vary between 10 to 25 mins. The terms ‘front exposure’ ‘rear exposure’ and ‘development time’ are well known in the area of printing.

The development time varies from 5 to 15 minutes depending on the features and criticality of the same incorporated in the plate.

In accordance with one embodiment of the process of the present invention, the method step of incorporating the feature on the substrate by print means is carried out by employing a fully automated, computer-controlled, customized Flexography printing technology which constitutes a flexo color deck, between-color drying system and sleeves mounted on special shafts by the aid of compressed air providing a fully integrated workflow to deliver secure and highest quality print and capable of integrating complex printing features including invisible anti-counterfeit print features, geometric, textural and striation patterns, ultra-small fonts, ultra fine lines, superimposition, continuous line, superfine and miniature text matter, image and/or patterns visible under high magnification with ultra-high precision and, self embossing and specialized coatings/inks and coating/inking technologies and invisible markers embedded within the printing resulting in a highly complex aluminum foil based printed packaging films and laminates having a blend of overt, overt-covert and ultra-covert security features.

Printing preparations are done on the basis of the print plan. A fully automated customized central ink management system comprising of computer controlled, pneumatically operated pumps and valves which is connected to a central distribution system with automatic turbo-cleaning option and integrated with online viscosity control system for precision print quality. The printing inks complies with various international standards and also residual volatile content of solvent and thus meets the requirements for applications in pharmaceutical, healthcare and medical applications.

The plates are mounted and the pressure is adjusted. The pressure is adjusted by moving the plates through specific distances. Greater the distance moved, greater will be the pressure. For example, if a pressure plate is moved through 60 microns then the pressure would be greater than the pressure when the plates are moved through a distance of 30 microns. In the context of the present invention, the pressure on the plate is therefore measured in terms of the distance through which the plate is moved.

In accordance with the process of the present invention at least one print parameter is selected for creating print plan which is selected from the group consisting of configuration of the anilox printer ranging between 70 to 340 lines per centimeter, speed within a range of about 60 meters per minute to about 350 meters per minute, the drying temperature between cylinders within a range of about 80° C. to about 130° C.; the drying temperature in tunnel within a range of about 120° C. to 160° C.; the tension on the rollers ranging between 120 to about 300 N/sq.m; plate pressure in the range of about 30 to 150 microns and the temperature of central impression drum ranging between 20 to 35° C.

Preferably, the drying temperature between the cylinders is maintained at 120 deg C. and in the tunnel is maintained at 140 deg C. for effective drying of the inks with minimum of retained residual solvent.

Typically, the machine is set at a speed to generate the right quality of print which may vary from 150 m/s to 350 m/s.

Typically, the tension is maintained between 120 to 300 N/sq m so as to get the right quality print on foil free from creases and proper winding quality at the unwinder, depending on the foil width & quality of the foil in terms of I value.

The entire printing process is set and monitored through a camera system equipped touch screen MMI. On completion of the print the deck loaded with the UV ink is to be cleaned with solvent to ensure that no traces of the UN Ink is present to contaminate the inks used for the next operation.

In accordance with one of the embodiments of the present invention, the method step of incorporating the discernible feature is carried out using a non-print means that is at least one selected from the group consisting of embossing means, coating means and lacquering means.

In accordance with one of the embodiments, the method step of incorporating the discernible feature involves the use of print means and the non-print means, both the menas being employed in a sequential manner.

Typically, the substrate is selected from the group consisting of thermoformable polymer film, thermoformable polymer laminate, heat sealable BOPP film, heat sealable BOPP laminate, heat seal lacquer coated glassine paper, aluminum based cold formable foil, aluminum based laminated strip foil and heat seal coated aluminum foil.

In accordance with one of the embodiments of the present invention, the process of the present invention employs an aluminum foil as the substrate and the printing is carried out using a “kiss-print” technique which involves a “kiss” impression wherein the printing plates are affixed to plate cylinders and are inked by a cell-structured, ink-metering “anilox” roll carrying a fast-drying fluid inks capable of printing on a variety of substrates. The pressure of the plate which generates the image by Kiss Impression is maintained through a closed loop system and adjusted to values of 30 to 350 micron.

The kiss-print technique in accordance with the present invention provides excellent readability of even the fine printed text matter and assurance of no damage and/or contamination to the foil during printing. The process comprising the following steps but not limited to: pre-press, multi-screen, ultra small fonts, ultra fine lines, low trappings, ultra fine super-imposition, continuous line, self-embossing and specialized coatings/inks and coating/inking technologies and/or invisible markers embedded within the printed matter resulting in a highly complex printed sealable aluminum foil based printed packaging foils, films and laminates providing discernible identity for authentication and anti-counterfeit measures for convenience packs such as blister and strip packs having a blend of overt, overt-covert and ultra-covert security features which is non-reproducible using any other conventional and standard printing technologies. Specialty polymeric plates are used for printing/lacquering/coating processes. The process provides excellent uniformity at significantly lower grammage of the sealing lacquers/coatings resulting in significantly higher productivity and lower wastages and no packs with unsealed portions due to uncoated patches. The process uses ultra thin deposition of lacquer/ink/coatings thus no entrapment of solvent and completely cured image/text/pattern which has significantly higher resistance to scuff/abrasion during packaging operations, transit and long term storage of the convenience packs such as blister and strip packs.

The invention is further illustrated by way of the following non-limiting examples.

### EXAMPLES

### Example 1

The art-work comprising a test logo with a text matter and an image was selected for preparing the packaging material of the present invention. Thermoformable monolayer blister film of PVC with a thickness of 250 micron was selected as a substrate for preparing the packaging material in accordance with the present invention.

Modification of the Art-work and Preparation of a Scheme for Incorporation of the Anti-Counterfeit Feature:

Specific set of letters from the logo were indentified for creating an anti-counterfeit feature by printing them with a selective visible marker that shows a blue glow under UV wavelength of 200-400 nm. A two color art work was designed for the remainder of the text and image. Another anti-counterfeit feature was included in the art work by incorporating a design for printing using machine readable distinctive marker. A further design for a print overcoat was also prepared.

Preparation of a Print Plan:

Taking into consideration the modified art-work and the scheme for incorporating the anti-counterfeit feature, a print plan was made.

The modified art-works along with the scheme for incorporation of the anti-counterfeit feature along with the print plan was stored in a database with unique reference number.

Print Process:

Five different plates were prepared for each of the designs and were developed. Provided herein below are the different exposure times used for developing the plates.
i. Plate 1: Exposure time—7 minutes Rear exposure and 22 minutes front exposure; Development time—11 minutes
ii. Plate 2: Exposure time—6 minutes Rear exposure and 18 minutes front exposure; Development time—14 minutes
iii. Plate 3: Exposure time—10 minutes Rear exposure and 20 minutes front exposure; Development time—12 minutes
iv. Plate 4: Exposure time—8 minutes Rear exposure and 16 minutes front exposure; Development time—10 minutes
v. Plate 5: Exposure time—5 minutes Rear exposure and 15 minutes front exposure; Development time—15 minutes

Printing preparations were done by identifying the suitable inks as per the schema and the print plan. The inks were prepared in the ink kitchen using the computerized ink management system. Pigmented inks in n-propanol solvent were selected for the flexographic printing. As per the schema and the print plan, inks were loaded into reservoirs with close loop circulation system. The machine readable distinct markers were loaded in accordance with print plan.

The plates were mounted on the cylinders and the pressure for each of the plates was adjusted to ensure a fine quality print.
Pressure for plate 1—55 micron
Pressure for plate 2—105 micron
Pressure for plate 3—60 micron
Pressure for plate 4—50 micron
Pressure for plate 5—80 micron

The substrate, a thermoformable monolayer blister film of PVC with a thickness of 250 micron was printed on the feloxographic printing machine with the following print parameters as stored in the print plan.

Machine-Run Parameters:
Viscosity of the inks used was 32 s
Speed: 150 mtrs./minute
Drying temperature between cylinders: 80° C.
Drying temperature in tunnel: 90° C.
Tension on rollers: 130 N/sq.m.
Temperature of Central Impression Drum: 32° C.

The printing process was set and continuously monitored through a camera system equipped with touch screen Man machine interface.

Different specimen packaging materials in accordance with the present invention were prepared by the process of the present invention by repeating the procedure in example No 1 with different tests logo samples, using different art-work designs by varying the print parameters.

### Example No: 2

Substrate Details:

Thermoformable multi layer blister film consisting of 120 micron PVC laminated with 30 microns PE.

Anti-Counterfeit Features:

Micro-text (Visible when viewed under 10×)

Art-Work Details:

designing 2. color for text, micro text cum image/pattern+1 design for over print coat

Plate Manufacturing:

5 plates as per the artwork design
i. Plate 1: Exposure time—7 minutes Rear exposure and 22 minutes front exposure; Development time—12 minutes
ii. Plate 2: Exposure time—6 minutes Rear exposure and 18 minutes front exposure; Development time—14 minutes
iii. Plate 3: Exposure time—10 minutes Rear exposure and 20 minutes front exposure; Development time—12 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—60 micron

Machine Run Parameters:
Speed: 200 mtrs./minute
Drying temperature between cylinders: 80° C.
Drying temperature in tunnel: 90° C.
Tension on rollers: 150 N/sq.m.
Temperature of Central Impression Drum: 32° C.

### Example No: 3

Substrate Details:

Thermoformable multilayer blister film consisting of 200 micron PVC Laminated with 25 microns PE and coated with 40 GSM of PVdC

Anti-Counterfeit Features:

Machine detectable Marker (Detectable by a machine)

UV Detectable Marker (Red glow under UV wavelength 200-400 nm)

Art-Work Details:

Artwork: 1 color for text/pattern having selective visibility with red glow under UV light of wavelength 200-400 nm+1 design for machine readable distinctive markers+1 design for over print coat

Plate Manufacturing:

Plate manufacturing: 3 plates as per the artwork design
i. Plate 1: Exposure time—10 minutes Rear exposure and 20 minutes front exposure; Development time—12 minutes
ii. Plate 2: Exposure time—8 minutes Rear exposure and 16 minutes front exposure; Development time—10 minutes
iii. Plate 3: Exposure time—5 minutes Rear exposure and 15 minutes front exposure; Development time—15 minutes

Print Process:

Measured viscosity of inks: 32 s

Mounted plates on cylinders & Adjusted pressure
Pressure for plate 1—60 micron
Pressure for plate 2—50 micron
Pressure for plate 3—80 micron

Machine Run Parameters:
Speed: 150 mtrs./minute
Drying temperature between cylinders: 80° C.
Drying temperature in tunnel: 90° C.
Tension on rollers: 150 N/sq.m.
Temperature of Central Impression Drum: 32° C.

### Example 4

Substrate Details:

Thermoformable multilayer blister film consisting of 100 micron PVC laminated with 30 microns PE

Anti-Counterfeit Features:

Machine detectable Marker (Detectable by a machine)

Art-Work Details:

Artwork: 1 design for machine readable distinctive markers+1 design for over print coat

Plate Manufacturing:

Plate manufacturing: 2 plates as per the artwork design
i. Plate 1: Exposure time—7 minutes Rear exposure and 15 minutes front exposure; Development time—12 minutes
ii. Plate 2: Exposure time—6 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—60 micron
Pressure for plate 2—80 micron

Machine Run Parameters:
Speed: 200 mtrs./minute
Drying temperature between cylinders: 80° C.
Drying temperature in tunnel: 90° C.
Tension on rollers: 150 N/sq.m.
Temperature of Central Impression Drum: 32° C.

### Example No 5

Substrate Details:

Thermoformable multilayer blister film consisting of 200 micron PVC laminated with 30 microns PE and coated with 60 GSM PVdC

Anti-Counterfeit Features:

Micro-text (Visible when viewed under 10×)

Machine detectable Marker (Detectable by a machine)

UV Detectable Marker (Yellow glow under UV wavelength 200-400 nm)

Art-Work Details:

Artwork: designing 2 color for text, micro text cum image/pattern+1 color for text/pattern having selective visibility with yellow glow under UV light of wavelength 200-400 nm+1 design for machine readable distinctive markers+1 design for over print coat

Plate Manufacturing:

4 plates as per the artwork design
i. Plate 1: Exposure time—7 minutes Rear exposure and 22 minutes front exposure; Development time—11 minutes
ii. Plate 2: Exposure time—6 minutes Rear exposure and 18 minutes front exposure; Development time—14 minutes
iii. Plate 3: Exposure time—10 minutes Rear exposure and 20 minutes front exposure; Development time—12 minutes
iv. Plate 4: Exposure time—8 minutes Rear exposure and 16 minutes front exposure; Development time—10 minutes
v. Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—60 micron
Pressure for plate 4—50 micron
Pressure for plate 5—80 micron

Machine Run Parameters:
Speed: 200 mtrs./minute
Drying temperature between cylinders: 80° C.
Drying temperature in tunnel: 90° C.
Tension on rollers: 150 N/sq.m.
Temperature of Central Impression Drum: 32° C.

The printed films as prepared in examples 1 to 5 were tested for the following print related functional and visual parameters:

Authentication Tests:

Machine readability of selective print zone embedded with unique markers

All above performed tests were conducted using standard/in-house specified test methods. Test results were satisfactory and complied to the requirements specified in the test methods.

Test for printed micro text position and legibility: The printed micro text was examined under 10× magnification and checked for its positional accuracy and readability. The micro text was found to be conforming to both positional accuracy and clarity in readability.

Test for selective print visibility under UV light: The selective print was exposed to UV light of wavelength 200-400 nm. The prints became visible with a distinct blue glow.

Test for confirmation of presence of embedded unique markers: The selective print zone embedded with unique markers was exposed to the machine reader. The machine was able to read the embedded marker and confirm the presence of marker was indicated by illumination of a green light.

Apart from the above authentication tests, the printed sample was further tested for other parameters: Print direction, Color shade, Layout/print text matter/micro text position & legibility, Heat resistance of print, Ink adhesion and Rub proofness of the print.

Stability Testing:

Printed film samples were subjected to stability at 25° C.±2° C. & 60% RH±5% RH and 40° C.±2° C. & 75% RH±5% RH for the period of 365 days & 180 days respectively and tested for print quality parameters.

Print quality test performed were—Ink Adhesion test, Heat Resistance test at 230° C., Rub proofness test, Selective print visibility with yellow glow under UV wavelength 200-400 nm, Machine readability of selective print zone embedded with unique markers and Visual appearance at the interval of 7 days up to 56 days and then by the interval of 30 days up to 365 days for the sample kept at 25 0 C±2 0 C & 60% RH±5% RH and 7 days up to 56 days and then by the interval of 30 days up to 180 days for the for 40 0 C±2 0 C & 75% RH±5% RH.

All test results were satisfactory and conformed to the specifications as specified in test methods.

Tests for Physical and Chemical Parameters:

The printed films were tested for the following film product physical & chemical parameters:
Thickness
Film, coating and printing GSM
Longitudinal and Transverse Dimensional stability
Longitudinal and Transverse Peak Elongation
Longitudinal and Transverse Tensile Strength
Impact strength
Heat sealability
Thermoformability
VCM content
Global migration
WVTR
FTIR identification
Odor absence
Fume liberation
leak test after blister formation
Volatile content
Toxicity

All above performed tests were conducted using standard/in-house specified test methods. Test results were satisfactory and complied to the requirements specified in the test methods.

### Example No 6

Substrate Details:

Heat sealable BOPP monolayer film of 15 micron

Anti-Counterfeit Features:

Micro-text (Visible when viewed under 10×)

UV Detectable Marker (yellow, red & half tone ornage glow under UV wavelength 200-400 nm)

Art-Work Details:

Artwork: designing 2 color for text, micro text cum image/pattern+2 color for text/pattern having selective visibility with yellow/red glow under UV light of wavelength 200-400 nm+1 design for over print coat

Plate Manufacturing:
i. Plate 1: Exposure time—7 minutes Rear exposure and 22 minutes front exposure; Development time—11 minutes
ii. Plate 2: Exposure time—6 minutes Rear exposure and 18 minutes front exposure; Development time—14 minutes
iii. Plate 3: Exposure time—10 minutes Rear exposure and 20 minutes front exposure; Development time—12 minutes
iv. Plate 4: Exposure time—8 minutes Rear exposure and 16 minutes front exposure; Development time—10 minutes
v. Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—80 micron
Pressure for plate 4—80 micron
Pressure for plate 5—80 micron

Machine Run Parameters:
Speed: 200 mtrs./minute
Drying temperature between cylinders: 80° C.
Drying temperature in tunnel: 90° C.
Tension on rollers: 150 N/sq.m.
Temperature of Central Impression Drum: 32° C.

The printed film as prepared in example 6 was tested for the print related functional and visual parameters as well as for physical & chemical parameters as provided in the example 1 to 5. All test results were satisfactory and conformed to the specifications as specified in test methods.

### Example No 7

Substrate Details:

Heat seal lacquered coated glassine paper of 40 GSM

Anti-Counterfeit Features:

Micro-text (Visible when viewed under 10×)

Machine detectable Marker (Detectable by a machine)

UV Detectable Marker (blue glow under UV wavelength 200-400 nm)

Art-Work Details:

designing 2 color for text, micro text cum image/pattern+1 color for text/pattern having selective visibility with blue glow under UV light of wavelength 200-400 nm+1 color for text/pattern having selective visibility with yellow glow under UV light of wavelength 200-400 nm+1 design for machine readable distinctive markers+1 design for over print coat

Plate Manufacturing:
(i) Plate 1: Exposure time—8 minutes Rear exposure and 20 minutes front exposure; Development time—12 minutes
(ii) Plate 2: Exposure time—6 minutes Rear exposure and 19 minutes front exposure; Development time—12 minutes
(iii) Plate 3: Exposure time—8 minutes Rear exposure and 21 minutes front exposure; Development time—12 minutes
(iv) Plate 4: Exposure time—8 minutes Rear exposure and 16 minutes front exposure; Development time—11 minutes
(v) Plate 5: Exposure time—6 minutes Rear exposure and 17 minutes front exposure; Development time—14 minutes
(vi) Plate 6: Exposure time—6 minutes Rear exposure and 16 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—80 micron
Pressure for plate 4—80 micron
Pressure for plate 5—80 micron

Machine Run Parameters:
Speed: 200 mtrs./minute
Drying temperature between cylinders: 80° C.
Drying temperature in tunnel: 90° C.
Tension on rollers: 150 N/sq.m.
Temperature of Central Impression Drum: 32° C.

The printed paper as prepared in example 7 was tested for the print related functional and visual parameters as provided in the example 1 to 5.

All test results were satisfactory and conformed to the specifications as specified in test methods.

Further the printed paper was tested for the following physical & chemical parameters
Thickness
Paper, coating and printing GSM
Longitudinal and Transverse Tensile Strength
Heat sealability
FTIR identification
Odor absence
Fume liberation
Toxicity

All above performed tests were conducted using standard/in-house specified test methods. Test results were satisfactory and complied to the requirements specified in the test methods

### Example No 8

Substrate Details:

Cold form blister foil 25 micron OPA, 50 micron Al & 60 micron PVC

Anti-Counterfeit Features:

Micro-text (Visible when viewed under 10×)

Machine detectable Marker (Detectable by a machine)

UV Detectable Marker (Yellow glow under UV wavelength 200-400 nm)

Art-Work Details:

Artwork: designing 2 color for text, micro text cum image/pattern+1 color for text/pattern having selective visibility with yellow glow under UV light of wavelength 200-400 nm+1 design for machine readable distinctive markers+1 design for over print coat

Plate Manufacturing:
(i) Plate 1: Exposure time—7 minutes Rear exposure and 22 minutes front exposure; Development time—11 minutes
(ii) Plate 2: Exposure time—6 minutes Rear exposure and 18 minutes front exposure; Development time—14 minutes
(iii) Plate 3: Exposure time—10 minutes Rear exposure and 20 minutes front exposure; Development time—12 minutes
(iv) Plate 4: Exposure time—8 minutes Rear exposure and 16 minutes front exposure; Development time—10 minutes
(v) Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & Adjusted pressure
Pressure for plate 1—55 micron
Pressure for plate 2—105 micron
Pressure for plate 3—60 micron
Pressure for plate 4—50 micron
Pressure for plate 5—80 micron

Machine Run Parameters:
Speed: 80 mtrs./minute
Drying temperature between cylinders: 120° C.
Drying temperature in tunnel: 140° C.
Tension on rollers: 150 N/sq.m.
Temperature of Central Impression Drum: 32° C.

### Example No 9

Substrate Details:

Cold form blister foil 25 micron OPA, 50 micron Al & 60 micron PVC

Anti-Counterfeit Features:

Micro-text (Visible when viewed under 10×)

Machine detectable Marker (Detectable by a machine)

UV Detectable Marker (Yellow & blue half tone glow under UV wavelength 200-400 nm)

Art-Work Details:

Artwork: designing 2 color for text, micro text cum image/pattern+2 color for text/pattern having selective visibility with yellow & blue half tone which in combination results in green glow under UV light of wavelength 200-400 nm+1 design for over print coat

Plate Manufacturing:
(i) Plate 1: Exposure time—7 minutes Rear exposure and 22 minutes front exposure; Development time—12 minutes
(ii) Plate 2: Exposure time—6 minutes Rear exposure and 18 minutes front exposure; Development time—14 minutes
(iii) Plate 3: Exposure time—10 minutes Rear exposure and 20 minutes front exposure; Development time—12 minutes
(iv) Plate 4: Exposure time—10 minutes Rear exposure and 20 minutes front exposure; Development time—12 minutes
(v) Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—60 micron
Pressure for plate 4—60 micron
Pressure for plate 5—80 micron

Machine Run Parameters:
Speed: 120 mtrs./minute
Drying temperature between cylinders: 120° C.
Drying temperature in tunnel: 140° C.
Tension on rollers: 150 N/sq.m.
Temperature of Central Impression Drum: 32° C.

### Example No 10

Substrate Details:

Cold form blister foil 25 micron OPA, 50 micron Al & 60 micron PVC

Anti-Counterfeit Features:

Micro-text (Visible when viewed under 10×)

Machine detectable Marker (Detectable by a machine)

UV Detectable Marker (Red glow under UV wavelength 200-400 nm)

Art-work details:

Artwork: designing 2 color for text, micro text cum image/pattern+1 color for text/pattern having selective visibility with red glow under UV light of wavelength 200—400 nm+1 color for text/pattern having selective visibility with Blue glow under UV light of wavelength 200-400 nm+1 design for machine readable distinctive markers+1 design for over print coat

Plate Manufacturing:
(i) Plate 1: Exposure time—7 minutes Rear exposure and 22 minutes front exposure; Development time—11 minutes
(ii) Plate 2: Exposure time—8 minutes Rear exposure and 20 minutes front exposure; Development time—11 minutes
(iii) Plate 3: Exposure time—6 minutes Rear exposure and 18 minutes front exposure; Development time—14 minutes
(iv) Plate 4: Exposure time—10 minutes Rear exposure and 20 minutes front exposure; Development time—12 minutes
(v) Plate 5: Exposure time—8 minutes Rear exposure and 16 minutes front exposure; Development time—10 minutes
(vi) Plate 6: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—65 micron
Pressure for plate 3—60 micron
Pressure for plate 4—60 micron
Pressure for plate 5—50 micron
Pressure for plate 6—80 micron

Machine Run Parameters:
Speed: 130 mtrs./minute
Drying temperature between cylinders: 120° C.
Drying temperature in tunnel: 140° C.
Tension on rollers: 150 N/sq.m.
Temperature of Central Impression Drum: 32° C.

### Example No 11

Substrate Details:

Cold form blister foil 25 micron OPA, 55 micron Al & 60 micron PVC

Anti-Counterfeit Features:

Micro-text (Visible when viewed under 10×)

Machine detectable Marker (Detectable by a machine)

UV Detectable Marker (blue glow under UV wavelength 200-400 nm)

Art-Work Details:

Artwork: designing 2 color for text, micro text cum image/pattern+1 color for text/pattern having selective visibility with blue glow under UV light of wavelength 200-400 nm+1 design for machine readable distinctive markers+1 design for over print coat

Plate Manufacturing:
i. Plate 1: Exposure time—7 minutes Rear exposure and 22 minutes front exposure; Development time—11 minutes
ii. Plate 2: Exposure time—6 minutes Rear exposure and 18 minutes front exposure; Development time—14 minutes
iii. Plate 3: Exposure time—5 minutes Rear exposure and 20 minutes front exposure; Development time—10 minutes
iv. Plate 4: Exposure time—8 minutes Rear exposure and 16 minutes front exposure; Development time—10 minutes
v. Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—80 micron
Pressure for plate 4—50 micron
Pressure for plate 5—80 micron

Machine Run Parameters:
Speed: 120 mtrs./minute
Drying temperature between cylinders: 120° C.
Drying temperature in tunnel: 140° C.
Tension on rollers: 150 N/sq.m.
Temperature of Central Impression Drum: 32° C.

### Example No 12

Substrate Details:

Cold form blister foil 25 micron OPA, 50 micron Al & 60 micron PVC

Anti-Counterfeit Features:

Micro-text (Visible when viewed under 10×)

Machine detectable Marker (Detectable by a machine)

UV Detectable Marker (Yellow glow under UV wavelength 200-400 nm)

Art-Work Details:

Artwork: designing 2 color for text, micro text cum image/pattern+1 color for text/pattern having selective visibility with yellow glow under UV light of wavelength 200-400 nm+1 design for machine readable distinctive markers+1 design for over print coat

Plate Manufacturing:
(i) Plate 1: Exposure time—7 minutes Rear exposure and 22 minutes front exposure; Development time—11 minutes
(ii) Plate 2: Exposure time—6 minutes Rear exposure and 18 minutes front exposure; Development time—14 minutes
(iii) Plate 3: Exposure time—10 minutes Rear exposure and 20 minutes front exposure; Development time—12 minutes
(iv) Plate 4: Exposure time—8 minutes Rear exposure and 16 minutes front exposure; Development time—10 minutes
(v) Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—60 micron
Pressure for plate 4—50 micron
Pressure for plate 5—80 micron

Machine Run Parameters:
Speed: 100 mtrs./minute
Drying temperature between cylinders: 120° C.
Drying temperature in tunnel: 140° C.
Tension on rollers: 150 N/sq.m.
Temperature of Central Impression Drum: 32° C.

### Example No 13

Substrate Details:

Cold form blister foil 25 micron OPA, 50 micron Al & 60 micron PVC

Anti-Counterfeit Features:

Micro-text (Visible when viewed under 10×)

Machine detectable Marker (Detectable by a machine)

UV Detectable Marker (Yellow, red & half tone orange glow under UV wavelength 200-400 nm)

Art-Work Details:

designing 2 color for text, micro text cum image/pattern+2 color for text/pattern having selective visibility with yellow/red glow under UV light of wavelength 200-400 nm+1 design for machine readable distinctive markers+1 design for over print coat

Plate Manufacturing:
i. Plate 1: Exposure time—7 minutes Rear exposure and 22 minutes front exposure; Development time—11 minutes
ii. Plate 2: Exposure time—6 minutes Rear exposure and 18 minutes front exposure; Development time—14 minutes
iii. Plate 3: Exposure time—10 minutes Rear exposure and 20 minutes front exposure; Development time—12 minutes
iv. Plate 4: Exposure time—8 minutes Rear exposure and 16 minutes front exposure; Development time—10 minutes
v. Plate 5: Exposure time—5 minutes Rear exposure and 15 minutes front exposure; Development time—15 minutes
vi. Plate 6: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—80 micron
Pressure for plate 4—80 micron
Pressure for plate 5—80 micron
Pressure for plate 5—80 micron

Machine Run Parameters:
Speed: 120 mtrs./minute
Drying temperature between cylinders: 120° C.
Drying temperature in tunnel: 140° C.
Tension on rollers: 150 N/sq.m.
Temperature of Central Impression Drum: 32° C.

The printed foil as prepared in examples 8-13 were tested for the print related functional and visual parameters as provided in the example 1 to 5.

All test results were satisfactory and conformed to the specifications as specified in test methods.

Further the printed foil was tested for the following physical & chemical parameters
Thickness
Laminate, coating and printing GSM
Pinholes
Elongation
Tensile Strength
Heat sealability
Odor absence
Fume liberation
leak test after blister formation
Volatile content
Toxicity

All above performed tests were conducted using standard/in-house specified test methods. Test results were satisfactory and complied to the requirements specified in the test methods.

### Example No 14

Substrate Details:

Al strip foil consisting of 30 micron Soft Tempered Al Foil Laminated with 38 microns PE

Anti-Counterfeit Features:

Micro-text (Visible when viewed under 10×)

Machine detectable Marker (Detectable by a machine)

UV Detectable Marker (Yellow glow under UV wavelength 200-400 nm)

Art-Work Details:

designing 2 color for text, micro text cum image/pattern+1 color for text/pattern having selective visibility with yellow glow under UV light of wavelength 200-400 nm+1 design for machine readable distinctive markers+1 design for over print coat

Plate Manufacturing:
(i) Plate 1: Exposure time—7 minutes Rear exposure and 22 minutes front exposure; Development time—11 minutes
(ii) Plate 2: Exposure time—6 minutes Rear exposure and 18 minutes front exposure; Development time—14 minutes
(iii) Plate 3: Exposure time—10 minutes Rear exposure and 20 minutes front exposure; Development time—12 minutes
(iv) Plate 4: Exposure time—8 minutes Rear exposure and 16 minutes front exposure; Development time—10 minutes
(v) Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—60 micron
Pressure for plate 4—50 micron
Pressure for plate 5—80 micron

Machine Run Parameters:
Speed: 150 mtrs./minute
Drying temperature between cylinders: 80° C.
Drying temperature in tunnel: 90° C.
Tension on rollers: 150 N/sq.m.
Temperature of Central Impression Drum: 32° C.

### Example No 15

Substrate Details:

Al strip foil consisting of 30 micron Soft Tempered Al Foil Laminated with 38 microns PE

Anti-Counterfeit Features:

Micro-text (Visible when viewed under 10×)

Machine detectable Marker (Detectable by a machine)

UV Detectable Marker (Yellow & green half tone glow under UV wavelength 200-400 nm)

Art-Work Details:

designing 2 color for text, micro text cum image/pattern+2 color for text/pattern having selective visibility with yellow & blue half tone which in combination results in green glow under UV light of wavelength 200-400 nm+1 design for over print coat

Plate Manufacturing:
(i) Plate 1: Exposure time—7 minutes Rear exposure and 22 minutes front exposure; Development time—12 minutes
(ii) Plate 2: Exposure time—6 minutes Rear exposure and 18 minutes front exposure; Development time—14 minutes
(iii) Plate 3: Exposure time—10 minutes Rear exposure and 20 minutes front exposure; Development time—12 minutes
(iv) Plate 4: Exposure time—10 minutes Rear exposure and 20 minutes front exposure; Development time—12 minutes
(v) Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders. Adjusted pressure
Pressure for plate 1—55 micron
Pressure for plate 2—105 micron
Pressure for plate 3—60 micron
Pressure for plate 4—60 micron
Pressure for plate 5—80 micron

Machine Run Parameters:
Speed: 200 mtrs./minute
Drying temperature between cylinders: 80° C.
Drying temperature in tunnel: 90° C.
Tension on rollers: 150 N/sq.m.
Temperature of Central Impression Drum: 32° C.

### Example No 16

Substrate Details:

Al strip foil consisting of 30 micron Soft Tempered Al Foil Laminated with 38 microns PE

Anti-Counterfeit Features:

Micro-text (Visible when viewed under 10×)

Machine detectable Marker (Detectable by a machine)

UV Detectable Marker (Red glow under UV wavelength 200-400 nm)

Art-Work Details:

Artwork: designing 3 color for text, micro text cum image/pattern+1 color for text/pattern having selective visibility with red glow under UV light of wavelength 200-400 nm+1 design for machine readable distinctive markers+1 design for over print coat

Plate Manufacturing:
(i) Plate 1: Exposure time—7 minutes Rear exposure and 22 minutes front exposure; Development time—11 minutes
(ii) Plate 2: Exposure time—8 minutes Rear exposure and 20 minutes front exposure; Development time—11 minutes
(iii) Plate 3: Exposure time—6 minutes Rear exposure and 18 minutes front exposure; Development time—14 minutes
(iv) Plate 4: Exposure time—10 minutes Rear exposure and 20 minutes front exposure; Development time—12 minutes
(v) Plate 5: Exposure time—8 minutes Rear exposure and 16 minutes front exposure; Development time—10 minutes
(vi) Plate 6: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—65 micron
Pressure for plate 3—60 micron
Pressure for plate 4—60 micron
Pressure for plate 5—50 micron
Pressure for plate 6—80 micron

Machine Run Parameters:
Speed: 150 mtrs./minute
Drying temperature between cylinders: 80° C.
Drying temperature in tunnel: 90° C.
Tension on rollers: 150 N/sq.m.
Temperature of Central Impression Drum: 32° C.

### Example No 17

Substrate Details:

Al strip foil consisting of 30 micron Soft Tempered Al Foil Laminated with 38 microns PE

Anti-Counterfeit Features:

Micro-text (Visible when viewed under 10×)

Machine detectable Marker (Detectable by a machine)

UV Detectable Marker (blue glow under UV wavelength 200-400 nm)

Art-Work Details:

designing 2 color for text, micro text cum image/pattern+1 color for text/pattern having selective visibility with blue glow under UV light of wavelength 200-400 nm+1 design for machine readable distinctive markers+1 design for over print coat

Plate Manufacturing:
(i) Plate 1: Exposure time—7 minutes Rear exposure and 22 minutes front exposure; Development time—11 minutes
(ii) Plate 2: Exposure time—6 minutes Rear exposure and 18 minutes front exposure; Development time—14 minutes
(iii) Plate 3: Exposure time—5 minutes Rear exposure and 20 minutes front exposure; Development time—10 minutes
(iv) Plate 4: Exposure time—8 minutes Rear exposure and 16 minutes front exposure; Development time—10 minutes
(v) Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—80 micron
Pressure for plate 4—50 micron
Pressure for plate 5—80 micron

Machine Run Parameters:
Speed: 200 mtrs./minute
Drying temperature between cylinders: 80° C.
Drying temperature in tunnel: 90° C.
Tension on rollers: 150 N/sq.m.
Temperature of Central Impression Drum: 32° C.

### Example No 18

Substrate Details:

Al strip foil consisting of 30 micron Soft Tempered Al Foil Laminated with 38 microns PE

Anti-Counterfeit Features:

Micro-text (Visible when viewed under 10×)

Machine detectable Marker (Detectable by a machine)

UV Detectable Marker (Yellow glow under UV wavelength 200-400 nm)

Art-Work Details:

designing 2 color for text, micro text cum image/pattern+1 color for text/pattern having selective visibility with yellow glow under UV light of wavelength 200-400 nm+1 design for machine readable distinctive markers+1 design for over print coat

Plate Manufacturing:
i. Plate 1: Exposure time—7 minutes Rear exposure and 22 minutes front exposure; Development time—11 minutes
ii. Plate 2: Exposure time—6 minutes Rear exposure and 18 minutes front exposure; Development time—14 minutes
iii. Plate 3: Exposure time—10 minutes Rear exposure and 20 minutes front exposure; Development time—12 minutes
iv. Plate 4: Exposure time—8 minutes Rear exposure and 16 minutes front exposure; Development time—10 minutes
v. Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—60 micron
Pressure for plate 4—50 micron
Pressure for plate 5—80 micron

Machine Run Parameters:
Speed: 200 mtrs./minute
Drying temperature between cylinders: 80° C.
Drying temperature in tunnel: 90° C.
Tension on rollers: 150 N/sq.m.
Temperature of Central Impression Drum: 32° C.

### Example No 19

Substrate Details:

Al strip foil consisting of 30 micron Soft Tempered Al Foil Laminated with 38 microns PE

Anti-Counterfeit Features:

Micro-text (Visible when viewed under 10×)

Machine detectable Marker (Detectable by a machine)

UV Detectable Marker (Yellow, red half tone orange glow under UV wavelength 200-400 nm)

Art-Work Details:

designing 2 color for text, micro text cum image/pattern+2 color for text/pattern having selective visibility with yellow/red glow under UV light of wavelength 200-400 nm+1 design for machine readable distinctive markers+1 design for over print coat

Plate Manufacturing:
(i) Plate 1: Exposure time—7 minutes Rear exposure and 22 minutes front exposure; Development time—11 minutes
(ii) Plate 2: Exposure time—6 minutes Rear exposure and 18 minutes front exposure; Development time—14 minutes
(iii) Plate 3: Exposure time—10 minutes Rear exposure and 20 minutes .front exposure; Development time—12 minutes
(iv) Plate 4: Exposure time—8 minutes Rear exposure and 16 minutes front exposure; Development time—10 minutes
(v) Plate 5: Exposure time—5 minutes Rear exposure and 15 minutes front exposure; Development time—15 minutes
(vi) Plate 6: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—80 micron
Pressure for plate 4—80 micron
Pressure for plate 5—80 micron
Pressure for plate 6—80 micron

Machine Run Parameters:
Speed: 200 mtrs./minute
Drying temperature between cylinders: 80° C.
Drying temperature in tunnel: 90° C.
Tension on rollers: 150 N/sq.m.
Temperature of Central Impression Drum: 32° C.

### Example No 20

Substrate Details:

Al strip foil consisting of 40 micron Soft Tempered Al Foil Laminated with 38 microns PE

Anti-Counterfeit Features:

Micro-text (Visible when viewed under 10×)

Machine detectable Marker (Detectable by a machine)

UV Detectable Marker (Yellow glow under UV wavelength 200-400 nm)

Art-Work Details:

designing 2 color for text, micro text cum image/pattern+1 color for text/pattern having selective visibility with yellow glow under UV light of wavelength 200-400 nm+1 design for machine readable distinctive markers+1 design for over print coat

Plate Manufacturing:
i. Plate 1: Exposure time—7 minutes Rear exposure and 22 minutes front exposure; Development time—11 minutes
ii. Plate 2: Exposure time—6 minutes Rear exposure and 18 minutes front exposure; Development time—14 minutes
iii. Plate 3: Exposure time—10 minutes Rear exposure and 20 minutes front exposure; Development time—12 minutes
iv. Plate 4: Exposure time—8 minutes Rear exposure and 16 minutes front exposure; Development time—10 minutes
v. Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—60 micron
Pressure for plate 4—50 micron
Pressure for plate 5—80 micron

Machine Run Parameters:
Speed: 150 mtrs./minute
Drying temperature between cylinders: 80° C.
Drying temperature in tunnel: 90° C.
Tension on rollers: 150 N/sq.m.
Temperature of Central Impression Drum: 32° C.

### Example No 21

Substrate Details:

Al strip foil consisting of 40 micron Soft Tempered Al Foil Laminated with 38 microns PE

Anti-Counterfeit Features:

Micro-text (Visible when viewed under 10×)

Machine detectable Marker (Detectable by a machine)

UV Detectable Marker (Yellow & green half tone glow under UV wavelength 200-400 nm)

Art-Work Details:

designing 2 color for text, micro text cum image/pattern+2 color for text/pattern having selective visibility with yellow & blue half tone which in Combination results in green glow under UV light of wavelength 200-400 nm+1 design for over print coat

Plate Manufacturing:
(i) Plate 1: Exposure time—7 minutes Rear exposure and 22 minutes front exposure; Development time—12 minutes
(ii) Plate 2: Exposure time—6 minutes Rear exposure and 18 minutes front exposure; Development time—14 minutes
(iii) Plate 3: Exposure time—10 minutes Rear exposure and 20 minutes front exposure; Development time—12 minutes
(iv) Plate 4: Exposure time—10 minutes Rear exposure and 20 minutes front exposure; Development time—12 minutes
(v) Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & Adjusted pressure
Pressure for plate 1—55 micron
Pressure for plate 2—105 micron
Pressure for plate 3—60 micron
Pressure for plate 4—60 micron
Pressure for plate 5—80 micron

Machine Run Parameters:
Speed: 200 mtrs./minute
Drying temperature between cylinders: 80° C.
Drying temperature in tunnel: 90° C.
Tension on rollers: 150 N/sq.m.
Temperature of Central Impression Drum: 32° C.

### Example No 22

Substrate Details:

Al strip foil consisting of 40 micron Soft Tempered Al Foil Laminated with 38 microns PE

Anti-Counterfeit Features:

Micro-text (Visible when viewed under 10×)

Machine detectable Marker (Detectable by a machine)

UV Detectable Marker (Red glow under UV wavelength 200-400 nm)

Art-Work Details:

designing 3 color for text, micro text cum image/pattern+1 color for text/pattern having selective visibility with red glow under UV light of wavelength 200-400 nm+1 design for machine readable distinctive markers+1 design for over print coat

Plate Manufacturing:
(i) Plate 1: Exposure time—7 minutes Rear exposure and 22 minutes front exposure; Development time—11 minutes
(ii) Plate 2: Exposure time—8 minutes Rear exposure and 20 minutes front exposure; Development time—11 minutes
(iii) Plate 3: Exposure time—6 minutes Rear exposure and 18 minutes front exposure; Development time—14 minutes
(iv) Plate 4: Exposure time—10 minutes Rear exposure and 20 minutes front exposure; Development time—12 minutes
(v) Plate 5: Exposure time—8 minutes Rear exposure and 16 minutes front exposure; Development time—10 minutes
(vi) Plate 6: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—65 micron
Pressure for plate 3—60 micron
Pressure for plate 4—60 micron
Pressure for plate 5—50 micron
Pressure for plate 6—80 micron

Machine Run Parameters:
Speed: 150 mtrs./minute
Drying temperature between cylinders: 80° C.
Drying temperature in tunnel: 90° C.
Tension on rollers: 150 N/sq.m.
Temperature of Central Impression Drum: 32° C.

### Example No 23

Substrate Details:

Al strip foil consisting of 40 micron Soft Tempered Al Foil Laminated with 38 microns PE

Anti-Counterfeit Features:

Micro-text (Visible when viewed under 10×)

Machine detectable Marker (Detectable by a machine)

UV Detectable Marker (blue glow under UV wavelength 200-400 nm)

Art-Work Details:

designing 2 color for text, micro text cum image/pattern+1 color for text/pattern having selective visibility with blue glow under UV light of wavelength 200-400 nm+1 design for machine readable distinctive markers+1 design for over print coat

Plate Manufacturing:
i. Plate 1: Exposure time—7 minutes Rear exposure and 22 minutes front exposure; Development time—11 minutes
ii. Plate 2: Exposure time—6 minutes Rear exposure and 18 minutes front exposure; Development time—14 minutes
iii. Plate 3: Exposure time—5 minutes Rear exposure and 20 minutes front exposure; Development time—10 minutes
iv. Plate 4: Exposure time—8 minutes Rear exposure and 16 minutes front exposure; Development time—10 minutes
v. Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & Adjusted pressure
Pressure for plate 1—55 micron
Pressure for plate 2—105 micron
Pressure for plate 3—80 micron
Pressure for plate 4—50 micron
Pressure for plate 5—80 micron

Machine Run Parameters:
Speed: 200 mtrs./minute
Drying temperature between cylinders: 80° C.
Drying temperature in tunnel: 90° C.
Tension on rollers: 150 N/sq.m.
Temperature of Central Impression Drum: 32° C.

### Example No 24

Substrate Details:

Al strip foil consisting of 40 micron Soft Tempered Al Foil Laminated with 38 microns PE

Anti-Counterfeit Features:

Micro-text (Visible when viewed under 10×)

Machine detectable Marker (Detectable by a machine)

UV Detectable Marker (Yellow glow under UV wavelength 200-400 nm)

Art-Work Details:

designing 2 color for text, micro text cum image/pattern+1 color for text/pattern having selective visibility with yellow glow under UV light of wavelength 200-400 nm+1 design for machine readable distinctive markers+1 design for over print coat

Plate Manufacturing:
(i) Plate 1: Exposure time—7 minutes Rear exposure and 22 minutes front exposure; Development time—11 minutes
(ii) Plate 2: Exposure time—6 minutes Rear exposure and 18 minutes front exposure; Development time—14 minutes
(iii) Plate 3: Exposure time—10 minutes Rear exposure and 20 minutes front exposure; Development time—12 minutes
(iv) Plate 4: Exposure time—8 minutes Rear exposure and 16 minutes front exposure; Development time—10 minutes
(v) Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—60 micron
Pressure for plate 4—50 micron
Pressure for plate 5—80 micron

Machine Run Parameters:
Speed: 200 mtrs./minute
Drying temperature between cylinders: 80° C.
Drying temperature in tunnel: 90° C.
Tension on rollers: 150 N/sq.m.
Temperature of Central Impression Drum: 32° C.

### Example No 25

Substrate Details:

Al strip foil consisting of 40 micron Soft Tempered Al Foil Laminated with 38 microns PE

Anti-Counterfeit Features:

Micro-text (Visible when viewed under 10×)

Machine detectable Marker (Detectable by a machine)

UV Detectable Marker (Yellow, red & half tone orange glow under UV wavelength 200-400 nm)

Art-Work Details:

designing 2 color for text, micro text cum image/pattern+2 color for text/pattern having selective visibility with yellow/red glow under UV light of wavelength 200-400 nm+1 design for machine readable distinctive markers+1 design for over print coat

Plate Manufacturing:
(i) Plate 1: Exposure time—7 minutes Rear exposure and 22 minutes front exposure; Development time—11 minutes
(ii) Plate 2: Exposure time—6 minutes Rear exposure and 18 minutes front exposure; Development time—14 minutes
(iii) Plate 3: Exposure time—10 minutes Rear exposure and 20 minutes front exposure; Development time—12 minutes
(iv) Plate 4: Exposure time—8 minutes Rear exposure and 16 minutes front exposure; Development time—10 minutes
(v) Plate 5: Exposure time—5 minutes Rear exposure and 15 minutes front exposure; Development time—15 minutes
(vi) Plate 6: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—80 micron
Pressure for plate 4—180 micron
Pressure for plate 5—80 micron
Pressure for plate 6—80 micron

Machine Run Parameters:
Speed: 200 mtrs./minute
Drying temperature between cylinders: 80° C.
Drying temperature in tunnel: 90° C.
Tension on rollers: 150 N/sq.m.
Temperature of Central Impression Drum: 32° C.

### Example No 26

Substrate Details:

7 gsm heat seal coated Plain Aluminum lidding foil of 30 microns

Anti-Counterfeit Features:

Micro-text (Visible when viewed under 10×)

Machine detectable Marker (Detectable by a machine)

UV Detectable Marker (Yellow e glow under UV wavelength 200-400 nm)

Art-Work Details:

Artwork: designing 2 color for text, micro text cum image/pattern+1 color for text/pattern having selective visibility with yellow glow under UV light of wavelength 200-400 nm+1 design for machine readable distinctive markers+1 design for over print coat

Plate Manufacturing:
(i) Plate 1: Exposure time—7 minutes Rear exposure and 22 minutes front exposure; Development time—11 minutes
(ii) Plate 2: Exposure time—6 minutes Rear exposure and 18 minutes front exposure; Development time—14 minutes
(iii) Plate 3: Exposure time—10 minutes Rear exposure and 20 minutes front exposure; Development time—12 minutes
(iv) Plate 4: Exposure time—8 minutes Rear exposure and 16 minutes front exposure; Development time—10 minutes
(v) Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—60 micron
Pressure for plate 4—50 micron
Pressure for plate 5—80 micron

Machine Run Parameters:
Speed: 200 mtrs./minute
Drying temperature between cylinders: 120° C.
Drying temperature in tunnel: 140° C.
Tension on rollers: 150 N/sq.m.
Temperature of Central Impression Drum: 32° C.

### Example No 27

Substrate Details:

7 gsm heat seal coated Plain Aluminum lidding foil of 30 microns

Anti-Counterfeit Features:

Micro-text (Visible when viewed under 10×)

Machine detectable Marker (Detectable by a machine)

UV Detectable Marker (Yellow &green half tone glow under UV wavelength 200-400 nm)

Art-Work Details:

designing 2 color for text, micro text cum image/pattern+2 color for text/pattern having selective visibility with yellow & blue half tone which in combination results in green glow under UV light of wavelength 200-400 nm+1 design for over print coat

Plate Manufacturing:
(i) Plate 1: Exposure time—7 minutes Rear exposure and 22 minutes front exposure; Development time—12 minutes
(ii) Plate 2: Exposure time—6 minutes Rear exposure and 18 minutes front exposure; Development time—14 minutes
(iii) Plate 3: Exposure time—10 minutes Rear exposure and 20 minutes front exposure; Development time—12 minutes
(iv) Plate 4: Exposure time—10 minutes Rear exposure and 20 minutes front exposure; Development time—12 minutes
(v) Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & Adjusted pressure
Pressure for plate 1—55 micron
Pressure for plate 2—105 micron
Pressure for plate 3—60 micron
Pressure for plate 4—60 micron
Pressure for plate 5—80 micron

Machine Run Parameters:
Speed: 200 mtrs./minute
Drying temperature between cylinders: 120° C.
Drying temperature in tunnel: 140° C.
Tension on rollers: 150 N/sq.m.
Temperature of Central Impression Drum: 32° C.

### Example No 28

Substrate Details:

7 gsm heat seal coated Plain Aluminum lidding foil of 30 microns

Anti-Counterfeit Features:

Micro-text (Visible when viewed under 10×)

Machine detectable Marker (Detectable by a machine)

UV Detectable Marker (Red glow under UV wavelength 200-400 nm)

Art-Work Details:

designing 3 color for text, micro text cum image/pattern+1 color for text/pattern having selective visibility with red glow under UV light of wavelength 200-400 nm+1 design for machine readable distinctive markers+1 design for over print coat

Plate Manufacturing:
(i) Plate 1: Exposure time—7 minutes Rear exposure and 22 minutes front exposure; Development time—11 minutes
(ii) Plate 2: Exposure time—8 minutes Rear exposure and 20 minutes front exposure; Development time—11 minutes
(iii) Plate 3: Exposure time—6 minutes Rear exposure and 18 minutes front exposure; Development time—14 minutes
(iv) Plate 4: Exposure time—10 minutes Rear exposure and 20 minutes front exposure; Development time—12 minutes
(v) Plate 5: Exposure time—8 minutes Rear exposure and 16 minutes front exposure; Development time—10 minutes
(vi) Plate 6: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—65 micron
Pressure for plate 3—60 micron
Pressure for plate 4—60 micron
Pressure for plate 5—50 micron
Pressure for plate 6—60 micron

Machine Run Parameters:
Speed: 250 mtrs./minute
Drying temperature between cylinders: 120° C.
Drying temperature in tunnel: 140° C.
Tension on rollers: 150 N/sq.m.
Temperature of Central Impression Drum: 32° C.

### Example No 29

Substrate Details:

7 gsm heat seal coated Plain Aluminum lidding foil of 30 microns

Anti-Counterfeit Features:

Micro-text (Visible when viewed under 10×)

Machine detectable Marker (Detectable by a machine)

UV Detectable Marker (blue glow under UV wavelength 200-400 nm)

Art-Work Details:

designing 2 color for text, micro text cum image/pattern+1 color for text/pattern having selective visibility with blue glow under UV light of wavelength 200-400 nm+1 design for machine readable distinctive markers+1 design for over print coat

Plate Manufacturing:
i. Plate 1: Exposure time—7 minutes Rear exposure and 22 minutes front exposure; Development time—11 minutes
ii. Plate 2: Exposure time—6 minutes Rear exposure and 18 minutes front exposure; Development time—14 minutes
iii. Plate 3: Exposure time—5 minutes Rear exposure and 20 minutes front exposure; Development time—10 minutes
iv. Plate 4: Exposure time—8 minutes Rear exposure and 16 minutes front exposure; Development time—10 minutes
v. Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—80 micron
Pressure for plate 4—50 micron
Pressure for plate 5—80 micron

Machine Run Parameters:
Speed: 300 mtrs./minute
Drying temperature between cylinders: 80° C.
Drying temperature in tunnel: 90° C.
Tension on rollers: 150 N/sq.m.
Temperature of Central Impression Drum: 32° C.

### Example No 30

Substrate Details:

7 gsm heat seal coated Plain Aluminum lidding foil of 30 microns

Anti-Counterfeit Features:

Micro-text (Visible when viewed under 10×)

Machine detectable Marker (Detectable by a machine)

UV Detectable Marker (Yellow glow under UV wavelength 200-400 nm)

Art-Work Details:

designing 2 color for text, micro text cum image/pattern+1 color for text/pattern having selective visibility with yellow glow under UV light of wavelength 200-400 nm+1 design for machine readable distinctive markers+1 design for over print coat

Plate Manufacturing:
i. Plate 1: Exposure time—7 minutes Rear exposure and 22 minutes front exposure; Development time—11 minutes
ii. Plate 2: Exposure time—6 minutes Rear exposure and 18 minutes front exposure; Development time—14 minutes
iii. Plate 3: Exposure time—10 minutes Rear exposure and 20 minutes front exposure; Development time—12 minutes
iv. Plate 4: Exposure time—8 minutes Rear exposure and 16 minutes front exposure; Development time—10 minutes
v. Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—60 micron
Pressure for plate 4—50 micron
Pressure for plate 5—80 micron

Machine Run Parameters:
Speed: 200 mtrs./minute
Drying temperature between cylinders: 120° C.
Drying temperature in tunnel: 140° C.
Tension on rollers: 150 N/sq.m.
Temperature of Central Impression Drum: 32° C.

### Example No 31

Substrate Details:

7 gsm heat seal coated Plain Aluminum lidding foil of 30 microns

Anti-Counterfeit Features:

Micro-text (Visible when viewed under 10×)

Machine detectable Marker (Detectable by a machine)

UV Detectable Marker (Yellow, red & half tone orange glow under UV wavelength 200-400 nm)

Art-Work Details:

designing 2 color for text, micro text cum image/pattern+2 color for text/pattern having selective visibility with yellow/red glow under UV light of wavelength 200-400 nm+1 design for machine readable distinctive markers+1 design for over print coat

Plate Manufacturing:
i. Plate 1: Exposure time—7 minutes Rear exposure and 22 minutes front exposure; Development time—11 minutes
ii. Plate 2: Exposure time—6 minutes Rear exposure and 18 minutes front exposure; Development time—14 minutes
iii. Plate 3: Exposure time—10 minutes Rear exposure and 20 minutes front exposure; Development time—12 minutes
iv. Plate 4: Exposure time—8 minutes Rear exposure and 16 minutes front exposure; Development time—10 minutes
v. Plate 5: Exposure time—5 minutes Rear exposure and 15 minutes front exposure; Development time—15 minutes
vi. Plate 6: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—80 micron
Pressure for plate 4—80 micron
Pressure for plate 5—80 micron
Pressure for plate 5—80 micron

Machine Run Parameters:
Speed: 250 mtrs./minute
Drying temperature between cylinders: 120° C.
Drying temperature in tunnel: 140° C.
Tension on rollers: 150 N/sq.m.
Temperature of Central Impression Drum: 32° C.

### Example No 32

Substrate Details:

7 gsm heat seal coated Plain Aluminum lidding foil of 30 microns

Anti-Counterfeit Features:

Micro-text (Visible when viewed under 10×)

Machine detectable Marker (Detectable by a machine)

IR Detectable Marker (Yellow glow under IR wavelength 100-300 micro m)

Art-Work Details:

designing 2 color for text, micro text cum image/pattern+1 color for text/pattern having selective visibility with yellow glow under IR light of wavelength 100-300 micro m+1 design for machine readable distinctive markers+1 design for over print coat

Plate Manufacturing:
(i) Plate 1: Exposure time—7 minutes Rear exposure and 22 minutes front exposure; Development time—11 minutes
(ii) Plate 2: Exposure time—6 minutes Rear exposure and 18 minutes front exposure; Development time—14 minutes
(iii) Plate 3: Exposure time—10 minutes Rear exposure and 20 minutes front exposure; Development time—12 minutes
(iv) Plate 4: Exposure time—8 minutes Rear exposure and 16 minutes front exposure; Development time—10 minutes
(v) Plate 5: Exposure time—5 minutes Rear exposure and 15 minutes front exposure; Development time—15 minutes

Print Process:

Ink preparation and ink loading into reservoirs with close loop circulation system

Measured viscosity of inks 32 s

Mounted plates on cylinders. Adjusted pressure
Pressure for plate 1—55 micron
Pressure for plate 2—105 micron
Pressure for plate 3—60 micron
Pressure for plate 4—50 micron
Pressure for plate 5—80 micron

Machine Run Parameters:
Speed: 200 mtrs./minute
Drying temperature between cylinders: 120° C.
Drying temperature in tunnel: 140° C.
Tension on rollers: 150 N/sq.m.
Temperature of Central Impression Drum: 32° C.

The printed foil as prepared in examples 14-32 were tested for the print related functional and visual parameters as provided in the example 1 to 5.

All test results were satisfactory and conformed to the specifications as specified in test methods.

Further the printed foil was tested for the following physical & chemical parameters
1. Thickness
2. Foil, coating and printing GSM
3. Pinholes
4. Elongation
5. Tensile Strength
6. Heat sealability
7. Odor absence
8. Fume liberation
9. leak test after blister formation
10. Volatile content
11. Toxicity

All above performed tests were conducted using standard/in-house specified test methods. Test results were satisfactory and complied to the requirements specified in the test methods.

### Example No 33

Substrate Details:

7 gsm heat seal coated Plain Aluminum lidding foil of 25 microns

Anti-Counterfeit Features:

Micro-text (Visible when viewed under 10×)

Machine detectable Marker (Detectable by a machine)

UV Detectable Marker (Yellow glow under UV wavelength 200-400 nm)

Art-Work Details:

designing 2 color for text, micro text cum image/pattern+1 color for text/pattern having selective visibility with yellow glow under UV light of wavelength 200-400 nm+1 design for machine readable distinctive markers+1 design for over print coat

Plate Manufacturing:
(i) Plate 1: Exposure time—7 minutes Rear exposure and 22 minutes front exposure; Development time—11 minutes
(ii) Plate 2: Exposure time—6 minutes Rear exposure and 18 minutes front exposure; Development time—14 minutes
(iii) Plate 3: Exposure time—10 minutes Rear exposure and 20 minutes front exposure; Development time—12 minutes
(iv) Plate 4: Exposure time—8 minutes Rear exposure and 16 minutes front exposure; Development time—10 minutes
(v) Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—60 micron
Pressure for plate 4—50 micron
Pressure for plate 5—80 micron

Machine Run Parameters:
Speed: 200 mtrs./minute
Drying temperature between cylinders: 120° C.
Drying temperature in tunnel: 140° C.
Tension on rollers: 150 N/sq.m.
Temperature of Central Impression Drum: 32° C.

### Example No 34

Substrate Details:

7 gsm heat seal coated Plain Aluminum lidding foil of 25 microns

Anti-Counterfeit Features:

Micro-text (Visible when viewed under 10×)

Machine detectable Marker (Detectable by a machine)

UV Detectable Marker (Yellow & green half tone glow under UV wavelength 200-400 nm)

Art-Work Details:

designing 2 color for text, micro text cum image/pattern+2 color for text/pattern having selective visibility with yellow & blue half tone which in combination results in green glow under UV light of wavelength 200-400 nm+1 design for over print coat

Plate Manufacturing:
(i) Plate 1: Exposure time—7 minutes Rear exposure and 22 minutes front exposure; Development time—12 minutes
(ii) Plate 2: Exposure time—6 minutes Rear exposure and 18 minutes front exposure; Development time—14 minutes
(iii) Plate 3: Exposure time—10 minutes Rear exposure and 20 minutes front exposure; Development time—12 minutes
(iv) Plate 4: Exposure time—10 minutes Rear exposure and 20 minutes front exposure; Development time—12 minutes
(v) Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—60 micron
Pressure for plate 4—60 micron
Pressure for plate 5—80 micron

Machine Run Parameters:
Speed: 200 mtrs./minute
Drying temperature between cylinders: 120° C.
Drying temperature in tunnel: 140° C.
Tension on rollers: 150 N/sq.m.
Temperature of Central Impression Drum: 32° C.

### Example No 35

Substrate Details:

7 gsm heat seal coated Plain Aluminum lidding foil of 25 microns

Anti-Counterfeit Features:

Micro-text (Visible when viewed under 10×)

Machine detectable Marker (Detectable by a machine)

UV Detectable Marker (Red glow under UV wavelength 200-400 nm)

Art-Work Details:

designing 3 color for text, micro text cum image/pattern+1 color for text/pattern having selective visibility with red glow under UV light of wavelength 200-400 nm+1 design for machine readable distinctive markers+1 design for over print coat

Plate Manufacturing:
i. Plate 1: Exposure time—7 minutes Rear exposure and 22 minutes front exposure; Development time—11 minutes
ii. Plate 2: Exposure time—8 minutes Rear exposure and 20 minutes front exposure; Development time—11 minutes
iii. Plate 3: Exposure time—6 minutes Rear exposure and 18 minutes front exposure; Development time—14 minutes
iv. Plate 4: Exposure time—10 minutes Rear exposure and 20 minutes front exposure; Development time—12 minutes
v. Plate 5: Exposure time—8 minutes Rear exposure and 16 minutes front exposure; Development time—10 minutes
vi. Plate 6: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—65 micron
Pressure for plate 3—60 micron
Pressure for plate 4—60 micron
Pressure for plate 5—80 micron

Machine Run Parameters:
Speed: 250 mtrs./minute
Drying temperature between cylinders: 120° C.
Drying temperature in tunnel: 140° C.
Tension on rollers: 150 N/sq.m.
Temperature of Central Impression Drum: 32° C.

### Example No 36

Substrate Details:

7 gsm heat seal coated Plain Aluminum lidding foil of 25 microns

Anti-Counterfeit Features:

Micro-text (Visible when viewed under 10×)

Machine detectable Marker (Detectable by a machine)

UV Detectable Marker (blue glow under UV wavelength 200-400 nm)

Art-Work Details:

designing 2 color for text, micro text cum image/pattern+1 color for text/pattern having selective visibility with blue glow under UV light of wavelength 200-400 nm+1 design for machine readable distinctive markers+1 design for over print coat

Plate Manufacturing:
(i) Plate 1: Exposure time—7 minutes Rear exposure and 22 minutes front exposure; Development time—11 minutes
(ii) Plate 2: Exposure time—6 minutes Rear exposure and 18 minutes front exposure; Development time—14 minutes
(iii) Plate 3: Exposure time—5 minutes Rear exposure and 20 minutes front exposure; Development time—10 minutes
(iv) Plate 4: Exposure time—8 minutes Rear exposure and 16 minutes front exposure; Development time—10 minutes
(v) Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—80 micron
Pressure for plate 4—50 micron
Pressure for plate 5—80 micron

Machine Run Parameters:
Speed: 300 mtrs./minute
Drying temperature between cylinders: 120° C.
Drying temperature in tunnel: 140° C.
Tension on rollers: 150 N/sq.m.
Temperature of Central Impression Drum: 32° C.

### Example No 37

Substrate Details:

7 gsm heat seal coated Plain Aluminum lidding foil of 25 microns

Anti-Counterfeit Features:

Micro-text (Visible when viewed under 10×)

Machine detectable Marker (Detectable by a machine)

UV Detectable Marker (Yellow glow under UV wavelength 200-400 nm)

Art-Work Details:

designing 2 color for text, micro text cum image/pattern+1 color for text/pattern having selective visibility with yellow glow under UV light of wavelength 200-400 nm+1 design for machine readable distinctive markers+1 design for over print coat

Plate Manufacturing:
Plate 1: Exposure time—7 minutes Rear exposure and 22 minutes front exposure; Development time—11 minutes
Plate 2: Exposure time—6 minutes Rear exposure and 18 minutes front exposure; Development time—14 minutes
Plate 3: Exposure time—10 minutes Rear exposure and 20 minutes front exposure; Development time—12 minutes
Plate 4: Exposure time—8 minutes Rear exposure and 16 minutes front exposure; Development time—10 minutes
Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—60 micron
Pressure for plate 4—50 micron
Pressure for plate 5—80 micron

Machine Run Parameters:
Speed: 200 mtrs./minute
Drying temperature between cylinders: 120° C.
Drying temperature in tunnel: 140° C.
Tension on rollers: 150 N/sq.m.
Temperature of Central Impression Drum: 32° C.

### Example No 38

Substrate Details:

7 gsm heat seal coated Plain Aluminum lidding foil of 25 microns

Anti-Counterfeit Features:

Micro-text (Visible when viewed under 10×)

Machine detectable Marker (Detectable by a machine)

UV Detectable Marker (Yellow, red & half tone orange glow under UV wavelength 200-400 nm)

Art-Work Details:

Plate Manufacturing:
i. Plate 1: Exposure time—7 minutes Rear exposure and 22 minutes front exposure; Development time—11 minutes
ii. Plate 2: Exposure time—6 minutes Rear exposure and 18 minutes front exposure; Development time—14 minutes
iii. Plate 3: Exposure time—10 minutes Rear exposure and 20 minutes front exposure; Development time—12 minutes
iv. Plate 4: Exposure time—8 minutes Rear exposure and 16 minutes front exposure; Development time—10 minutes
v. Plate 5: Exposure time—5 minutes Rear exposure and 15 minutes front exposure; Development time—15 minutes
vi. Plate 6: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—80 micron
Pressure for plate 4—80 micron
Pressure for plate 5—80 micron
Pressure for plate 6—80 micron

Machine Run Parameters:
Speed: 250 mtrs./minute
Drying temperature between cylinders: 120° C.
Drying temperature in tunnel: 140° C.
Tension on rollers: 150 N/sq.m.
Temperature of Central Impression Drum: 32° C.

### Example No 39

Substrate Details:

7 gsm heat seal coated Plain Aluminum lidding foil of 25 microns

Anti-Counterfeit Features:

Micro-text (Visible when viewed under 10×)

Machine detectable Marker (Detectable by a machine)

IR Detectable Marker (Yellow glow under IR wavelength 100-300 micro m)

Art-Work Details:

designing 2 color for text, micro text cum image/pattern+1 color for text/pattern having selective visibility with yellow glow under IR light of wavelength 100-300 micro m+1 design for machine readable distinctive markers+1 design for over print coat

Plate Manufacturing:
i. Plate 1: Exposure time—7 minutes Rear exposure and 22 minutes front exposure; Development time—11 minutes
ii. Plate 2: Exposure time—6 minutes Rear exposure and 18 minutes front exposure; Development time—14 minutes
iii. Plate 3: Exposure time—10 minutes Rear exposure and 20 minutes front exposure; Development time—12 minutes
iv. Plate 4: Exposure time—8 minutes Rear exposure and 16 minutes front exposure; Development time—10 minutes
v. Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—60 micron
Pressure for plate 4—50 micron
Pressure for plate 5—80 micron

Machine Run Parameters:
Speed: 200 mtrs./minute
Drying temperature between cylinders: 120° C.
Drying temperature in tunnel: 140° C.
Tension on rollers: 150 N/sq.m.
Temperature of Central Impression Drum: 32° C.

### Example No 40

Substrate Details:

5 gsm heat seal coated Plain Aluminum lidding foil of 25 microns

Anti-Counterfeit Features:

Micro-text (Visible when viewed under 10×)

Machine detectable Marker (Detectable by a machine)

UV Detectable Marker (Yellow glow under UV wavelength 200-400 nm)

Art-Work Details:

designing 2 color for text, micro text cum image/pattern+1 color for text/pattern having selective visibility with yellow glow under UV light of wavelength 200-400 nm+1 design for machine readable distinctive markers+1 design for over print coat

Plate Manufacturing:
i. Plate 1: Exposure time—7 minutes Rear exposure and 22 minutes front exposure; Development time—11 minutes
ii. Plate 2: Exposure time—6 minutes Rear exposure and 18 minutes front exposure; Development time—14 minutes
iii. Plate 3: Exposure time—10 minutes Rear exposure and 20 minutes front exposure; Development time—12 minutes
iv. Plate 4: Exposure time—8 minutes Rear exposure and 16 minutes front exposure; Development time—10 minutes
v. Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—60 micron
Pressure for plate 4—50 micron
Pressure for plate 5.—80 micron

Machine Run Parameters:
Speed: 200 mtrs./minute
Drying temperature between cylinders: 120° C.
Drying temperature in tunnel: 140° C.
Tension on rollers: 150 N/sq.m.
Temperature of Central Impression Drum: 32° C.

### Example No 41

Substrate Details:

5 gsm heat seal coated Plain Aluminum lidding foil of 25 microns

Anti-Counterfeit Features:

Micro-text (Visible when viewed under 10×)

Machine detectable Marker (Detectable by a machine)

UV Detectable Marker (Yellow & green half tone glow under UV wavelength 200-400 run)

Art-Work Details:

designing 2 color for text, micro text cum image/pattern+2 color for text/pattern having selective visibility with yellow & blue half tone which in combination results in green glow under UV light of wavelength 200-400 nm+1 design for over print coat

Plate Manufacturing:
(i) Plate 1: Exposure time—7 minutes Rear exposure and 22 minutes front exposure; Development time—12 minutes
(ii) Plate 2: Exposure time—6 minutes Rear exposure and 18 minutes front exposure; Development time—14 minutes
(iii) Plate 3: Exposure time—10 minutes Rear exposure and 20 minutes front exposure; Development time—12 minutes
(iv) Plate 4: Exposure time—10 minutes Rear exposure and 20 minutes front exposure; Development time—12 minutes
(v) Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—60 micron
Pressure for plate 4—60 micron
Pressure for plate 5—80 micron

Machine Run Parameters:
Speed: 200 mtrs./minute
Drying temperature between cylinders: 120° C.
Drying temperature in tunnel: 140° C.
Tension on rollers: 150 N/sq.m.
Temperature of Central Impression Drum: 32° C.

### Example No 42

Substrate Details:

5 gsm heat seal coated Plain Aluminum lidding foil of 25 microns

Anti-Counterfeit Features:

Micro-text (Visible when viewed under 10×)

Machine detectable Marker (Detectable by a machine)

UV Detectable Marker (Red glow under UV wavelength 200-400 nm)

Art-Work Details:

designing 3 color for text, micro text cum image/pattern+1 color for text/pattern having selective visibility with red glow under UV light of wavelength 200-400 nm+1 design for machine readable distinctive markers+1 design for over print coat

Plate Manufacturing:
i. Plate 1: Exposure time—7 minutes Rear exposure and 22 minutes front exposure; Development time—11 minutes
ii. Plate 2: Exposure time—8 minutes Rear exposure and 20 minutes front exposure; Development time—11 minutes
iii. Plate 3: Exposure time—6 minutes Rear exposure and 18 minutes front exposure; Development time—14 minutes
iv. Plate 4: Exposure time—10 minutes Rear exposure and 20 minutes front exposure; Development time—12 minutes
v. Plate 5: Exposure time—8 minutes Rear exposure and 16 minutes front exposure; Development time—10 minutes
vi. Plate 6: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—65 micron
Pressure for plate 3—60 micron
Pressure for plate 4—60 micron
Pressure for plate 5—50 micron
Pressure for plate 6—80 micron

Machine Run Parameters:
Speed: 200 mtrs./minute
Drying temperature between cylinders: 120° C.
Drying temperature in tunnel: 140° C.
Tension on rollers: 150 N/sq.m.
Temperature of Central Impression Drum: 32° C.

### Example No 43

Substrate Details:

5 gsm heat seal coated Plain Aluminum lidding foil of 25 microns

Anti-Counterfeit Features:

Micro-text (Visible when viewed under 10×)

Machine detectable Marker (Detectable by a machine)

UV Detectable Marker (blue glow under UV wavelength 200-400 nm)

Art-Work Details:

designing 2 color for text, micro text cum image/pattern+1 color for text/pattern having selective visibility with blue glow under UV light of wavelength 200-400 nm+1 design for machine readable distinctive markers+1 design for over print coat

Plate Manufacturing:
(i) Plate 1: Exposure time—7 minutes Rear exposure and 22 minutes front exposure; Development time—11 minutes
(ii) Plate 2: Exposure time—6 minutes Rear exposure and 18 minutes front exposure; Development time—14 minutes
(iii) Plate 3: Exposure time—5 minutes Rear exposure and 20 minutes front exposure; Development time—10 minutes
(iv) Plate 4: Exposure time—8 minutes Rear exposure and 16 minutes front exposure; Development time—10 minutes
(v) Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & Adjusted pressure
Pressure for plate 1—55 micron
Pressure for plate 2—105 micron
Pressure for plate 3—80 micron
Pressure for plate 4—50 micron
Pressure for plate 5—80 micron

Machine Run Parameters:
Speed: 300 mtrs./minute
Drying temperature between cylinders: 120° C.
Drying temperature in tunnel: 140° C.
Tension on rollers: 150 N/sq.m.
Temperature of Central Impression Drum: 32° C.

### Example No 44

Substrate Details:

5 gsm heat seal coated Plain Aluminum lidding foil of 25 microns

Anti-Counterfeit Features:

Micro-text (Visible when viewed under 10×)

Machine detectable Marker (Detectable by a machine)

UV Detectable Marker (Yellow glow under UV wavelength 200-400 nm)

Art-Work Details:

designing 2 color for text, micro text cum image/pattern+1 color for text/pattern having selective visibility with yellow glow under UV light of wavelength 200-400 nm+1 design for machine readable distinctive markers+1 design for over print coat

Plate Manufacturing:
(i) Plate 1: Exposure time—7 minutes Rear exposure and 22 minutes front exposure; Development time—11 minutes
(ii) Plate 2: Exposure time—6 minutes Rear exposure and 18 minutes front exposure; Development time—14 minutes
(iii) Plate 3: Exposure time—10 minutes Rear exposure and 20 minutes front exposure; Development time—12 minutes
(iv) Plate 4: Exposure time—8 minutes Rear exposure and 16 minutes front exposure; Development time—10 minutes
(v) Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—60 micron
Pressure for plate 4—50 micron
Pressure for plate 5—80 micron

Machine Run Parameters:
Speed: 200 mtrs./minute
Drying temperature between cylinders: 120° C.
Drying temperature in tunnel: 140° C.
Tension on rollers: 150 N/sq.m.
Temperature of Central Impression Drum: 32° C.

### Example No 45

Substrate Details:

5 gsm heat seal coated Plain Aluminum lidding foil of 25 microns

Anti-counterfeit Features:

Micro-text (Visible when viewed under 10×)

Machine detectable Marker (Detectable by a machine)

UV Detectable Marker (Yellow, red & half tone orange glow under UV wavelength 200-400 nm)

Art-Work Details:

designing 2 color for text, micro text cum image/pattern+2 color for text/pattern having selective visibility with yellow/red glow under UV light of wavelength 200-400 nm+1 design for machine readable distinctive markers+1 design for over print coat

Plate Manufacturing:
i. Plate 1: Exposure time—7 minutes Rear exposure and 22 minutes front exposure; Development time—11 minutes
ii. Plate 2: Exposure time—6 minutes Rear exposure and 18 minutes front exposure; Development time—14 minutes
iii. Plate 3: Exposure time—10 minutes Rear exposure and 20 minutes front exposure; Development time—12 minutes
iv. Plate 4: Exposure time—8 minutes Rear exposure and 16 minutes front exposure; Development time—10 minutes
v. Plate 5: Exposure time—5 minutes Rear exposure and 15 minutes front exposure; Development time—15 minutes
vi. Plate 6: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—80 micron
Pressure for plate 4—80 micron
Pressure for plate 5—80 micron
Pressure for plate 6—80 micron

Machine Run Parameters:
Speed: 250 mtrs./minute
Drying temperature between cylinders: 120° C.
Drying temperature in tunnel: 140° C.
Tension on rollers: 150 N/sq.m.
Temperature of Central Impression Drum: 32° C.

### Example No 46

Substrate Details:

5 gsm heat seal coated Plain Aluminum lidding foil of 25 microns

Anti-Counterfeit Features:

Micro-text (Visible when viewed under 10×)

Machine detectable Marker (Detectable by a machine)

IR Detectable Marker (Yellow glow under IR wavelength 100-300 micro m)

Art-Work Details:

designing 2 color for text, micro text cum image/pattern+1 color for text/pattern having selective visibility with yellow glow under IR light of wavelength 100-300 micro m+1 design for machine readable distinctive markers+1 design for over print coat

Plate Manufacturing:
(i) Plate 1: Exposure time—7 minutes Rear exposure and 22 minutes front exposure; Development time—11 minutes
(ii) Plate 2: Exposure time—6 minutes Rear exposure and 18 minutes front exposure; Development time—14 minutes
(iii) Plate 3: Exposure time—10 minutes Rear exposure and 20 minutes front exposure; Development time—12 minutes
(iv) Plate 4: Exposure time—8 minutes Rear exposure and 16 minutes front exposure; Development time—10 minutes
(v) Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—60 micron
Pressure for plate 4—50 micron
Pressure for plate 5—80 micron

Machine Run Parameters:
Speed: 200 mtrs./minute
Drying temperature between cylinders: 120° C.
Drying temperature in tunnel: 140° C.
Tension on rollers: 150 N/sq.m.
Temperature of Central Impression Drum: 32° C.

### Example No 47

Substrate Details:

5 gsm heat seal coated Plain Aluminum lidding foil of 20 microns

Anti-counterfeit Features:

Micro-text (Visible when viewed under 10×)

Machine detectable Marker (Detectable by a machine)

UV Detectable Marker (Yellow glow under UV wavelength 200-400 nm)

Art-Work Details:

designing 2 color for text, micro text cum image/pattern+1 color for text/pattern having selective visibility with yellow glow under UV light of wavelength 200-400 nm+1 design for machine readable distinctive markers+1 design for over print coat

Plate Manufacturing:
i. Plate 1: Exposure time—7 minutes Rear exposure and 22 minutes front exposure; Development time—11 minutes
ii. Plate 2: Exposure time—6 minutes Rear exposure and 18 minutes front exposure; Development time—14 minutes
iii. Plate 3: Exposure time—10 minutes Rear exposure and 20 minutes front exposure; Development time—12 minutes
iv. Plate 4: Exposure time—8 minutes Rear exposure and 16 minutes front exposure; Development time—10 minutes
v. Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—60 micron
Pressure for plate 4—50 micron
Pressure for plate 5—80 micron

Machine Run Parameters:
Speed: 200 mtrs./minute
Drying temperature between cylinders: 120° C.
Drying temperature in tunnel: 140° C.
Tension on rollers: 150 N/sq.m.
Temperature of Central Impression Drum: 32° C.

### Example No 48

Substrate Details:

5 gsm heat seal coated Plain Aluminum lidding foil of 20 microns

Anti-Counterfeit Features:

Micro-text (Visible when viewed under 10×)

Machine detectable Marker (Detectable by a machine)

UV Detectable Marker (Yellow & green half tone glow under UV wavelength 200-400 nm)

Art-Work Details:

designing 2 color for text, micro text cum image/pattern+2 color for text/pattern having selective visibility with yellow & blue half tone which in combination results in green glow under UV light of wavelength 200-400 nm+1 design for over print coat

Plate Manufacturing:
(i) Plate 1: Exposure time—7 minutes Rear exposure and 22 minutes front exposure; Development time—12 minutes
(ii) Plate 2: Exposure time—6 minutes Rear exposure and 18 minutes front exposure; Development time—14 minutes
(iii) Plate 3: Exposure time—10 minutes Rear exposure and 20 minutes front exposure; Development time—12 minutes
(iv) Plate 4: Exposure time—10 minutes Rear exposure and 20 minutes front exposure; Development time—12 minutes
(v) Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—60 micron
Pressure for plate 4—60 micron
Pressure for plate 5—80 micron

Machine Run Parameters:
Speed: 200 mtrs./minute
Drying temperature between cylinders: 120° C.
Drying temperature in tunnel: 140° C.
Tension on rollers: 150 N/sq.m.
Temperature of Central Impression Drum: 32° C.

### Example No 49

Substrate Details:

5 gsm heat seal coated Plain Aluminum lidding foil of 20 microns

Anti-Counterfeit Features:

Micro-text (Visible when viewed under 10×)

Machine detectable Marker (Detectable by a machine)

UV Detectable Marker (Red glow under UV wavelength 200-400 nm)

Art-Work Details:

designing 3 color for text, micro text cum image/pattern+1 color for text/pattern having selective visibility with red glow under UV light of wavelength 200-400 nm+1 design for machine readable distinctive markers+1 design for over print coat

Plate Manufacturing:
i. Plate 1: Exposure time—7 minutes Rear exposure and 22 minutes front exposure; Development time—11 minutes
ii. Plate 2: Exposure time—8 minutes Rear exposure and 20 minutes front exposure; Development time—11 minutes
iii. Plate 3: Exposure time—6 minutes Rear exposure and 18 minutes front exposure; Development time—14 minutes
iv. Plate 4: Exposure time—10 minutes Rear exposure and 20 minutes front exposure; Development time—12 minutes
v. Plate 5: Exposure time—8 minutes Rear exposure and 16 minutes front exposure; Development time—10 minutes
vi. Plate 6: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—65 micron
Pressure for plate 3—60 micron
Pressure for plate 4—60 micron
Pressure for plate 5—50 micron
Pressure for plate 6—80 micron

Machine Run Parameters:
Speed: 250 mtrs./minute
Drying temperature between cylinders: 120° C.
Drying temperature in tunnel: 140° C.
Tension on rollers: 150 N/sq.m.
Temperature of Central Impression Drum: 32° C.

### Example No 50

Substrate Details:

5 gsm heat seal coated Plain Aluminum lidding foil of 20 microns

Anti-Counterfeit Features:

Micro-text (Visible when viewed under 10×)

Machine detectable Marker (Detectable by a machine)

UV Detectable Marker (blue glow under UV wavelength 200-400 nm)

Art-Work Details:

designing 2 color for text, micro text cum image/pattern+1 color for text/pattern having selective visibility with blue glow under UV light of wavelength 200-400 nm+1 design for machine readable distinctive markers+1 design for over print coat

Plate Manufacturing:
Plate 1: Exposure time—7 minutes Rear exposure and 22 minutes front exposure; Development time—11 minutes
Plate 2: Exposure time—6 minutes Rear exposure and 18 minutes front exposure; Development time—14 minutes
Plate 3: Exposure time—5 minutes Rear exposure and 20 minutes front exposure; Development time—10 minutes
Plate 4: Exposure time—8 minutes Rear exposure and 16 minutes front exposure; Development time—10 minutes
Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—80 micron
Pressure for plate 4—50 micron
Pressure for plate 5—80 micron

Machine Run Parameters:
Speed: 300 mtrs./minute
Drying temperature between cylinders: 120° C.
Drying temperature in tunnel: 140° C.
Tension on rollers: 150 N/sq.m.
Temperature of Central Impression Drum: 32° C.

### Example No 51

Substrate Details:

5 gsm heat seal coated Plain Aluminum lidding foil of 20 microns

Anti-Counterfeit Features:

Micro-text (Visible when viewed under 10×)

Machine detectable Marker (Detectable by a machine)

UV Detectable Marker (Yellow glow under UV wavelength 200-400 nm)

Art-Work Details:

designing 2 color for text, micro text cum image/pattern+1 color for text/pattern having selective visibility with yellow glow under UV light of wavelength 200-400 nm+1 design for machine readable distinctive markers+1 design for over print coat

Plate Manufacturing:
(i) Plate 1: Exposure time—7 minutes Rear exposure and 22 minutes front exposure; Development time—11 minutes
(ii) Plate 2: Exposure time—6 minutes Rear exposure and 18 minutes front exposure; Development time—14 minutes
(iii) Plate 3: Exposure time—10 minutes Rear exposure and 20 minutes front exposure; Development time—12 minutes
(iv) Plate 4: Exposure time—8 minutes Rear exposure and 16 minutes front exposure; Development time—10 minutes
(v) Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—60 micron
Pressure for plate 4—50 micron
Pressure for plate 5—80 micron

Machine Run Parameters:
Speed: 200 mtrs./minute
Drying temperature between cylinders: 120° C.
Drying temperature in tunnel: 140° C.
Tension on rollers: 150 N/sq.m.
Temperature of Central Impression Drum: 32° C.

### Example No 52

Substrate Details:

5 gsm heat seal coated Plain Aluminum lidding foil of 20 microns

Anti-Counterfeit Features:

Micro-text (Visible when viewed under 10×)

Machine detectable Marker (Detectable by a machine)

UV Detectable Marker (Yellow, red & half tone orange glow under UV wavelength 200-400 nm)

Art-Work Details:

designing 2 color for text, micro text cum image/pattern+2 color for text/pattern having selective visibility with yellow/red glow under UV light of wavelength 200-400 nm+1 design for machine readable distinctive markers+1 design for over print coat

Plate Manufacturing:
i. Plate 1: Exposure time—7 minutes Rear exposure and 22 minutes front exposure; Development time—11 minutes
ii. Plate 2: Exposure time—6 minutes Rear exposure and 18 minutes front exposure; Development time—14 minutes
iii. Plate 3: Exposure time—10 minutes Rear exposure and 20 minutes front exposure; Development time—12 minutes
iv. Plate 4: Exposure time—8 minutes Rear exposure and 16 minutes front exposure; Development time—10 minutes
v. Plate 5: Exposure time—5 minutes Rear exposure and 15 minutes front exposure; Development time—15 minutes
vi. Plate 6: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—80 micron
Pressure for plate 4—80 micron
Pressure for plate 5—80 micron
Pressure for plate 6—80 micron

Machine Run Parameters:
Speed: 250 mtrs./minute
Drying temperature between cylinders: 120° C.
Drying temperature in tunnel: 140° C.
Tension on rollers: 150 N/sq.m.
Temperature of Central Impression Drum: 32° C.

### Example No 53

Substrate Details: 5 gsm heat seal coated Plain Aluminum lidding foil of 20 microns

Anti-Counterfeit Features:

Micro-text (Visible when viewed under 10×)

Machine detectable Marker (Detectable by a machine)

IR Detectable Marker (Yellow glow under IR wavelength 100-300 micro m)

Art-Work Details:

designing 2 color for text, micro text cum image/pattern+1 color for text/pattern having selective visibility with yellow glow under IR light of wavelength 100-300 micro m+1 design for machine readable distinctive markers+1 design for over print coat

Plate Manufacturing:
(i) Plate 1: Exposure time—7 minutes Rear exposure and 22 minutes front exposure; Development time—11 minutes
(ii) Plate 2: Exposure time—6 minutes Rear exposure and 18 minutes front exposure; Development time—14 minutes
(ii) Plate 3: Exposure time—10 minutes Rear exposure and 20 minutes front exposure; Development time—12 minutes
(iv) Plate 4: Exposure time—8 minutes Rear exposure and 16 minutes front exposure; Development time—10 minutes
(v) Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—60 micron
Pressure for plate 4—50 micron
Pressure for plate 5—80 micron

Machine Run Parameters:
Speed: 200 mtrs./minute
Drying temperature between cylinders: 120° C.
Drying temperature in tunnel: 140° C.
Tension on rollers: 150 N/sq.m.
Temperature of Central Impression Drum: 32° C.

### Example No 54

Substrate Details:

7 gsm heat seal coated Plain Aluminum lidding foil of 20 microns

Anti-Counterfeit Features:

Micro-text (Visible when viewed under 10×)

Machine detectable Marker (Detectable by a machine)

UV Detectable Marker (Yellow glow under UV wavelength 200-400 nm)

Art-Work Details:

designing 2 color for text, micro text cum image/pattern+1 color for text/pattern having selective visibility with yellow glow under UV light of wavelength 200-400 nm+1 design for machine readable distinctive markers+1 design for over print coat

Plate Manufacturing:
(i) Plate 1: Exposure time—7 minutes Rear exposure and 22 minutes front exposure; Development time—11 minutes
(ii) Plate 2: Exposure time—6 minutes Rear exposure and 18 minutes front exposure; Development time—14 minutes
(iii) Plate 3: Exposure time—10 minutes Rear exposure and 20 minutes front exposure; Development time—12 minutes
(iv) Plate 4: Exposure time—8 minutes Rear exposure and 16 minutes front exposure; Development time—10 minutes
(v) Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—60 micron
Pressure for plate 4—50 micron
Pressure for plate 5—80 micron

Machine Run Parameters:
Speed: 200 mtrs./minute
Drying temperature between cylinders: 120° C.
Drying temperature in tunnel: 140° C.
Tension on rollers: 150 N/sq.m.
Temperature of Central Impression Drum: 32° C.

### Example No 55

Substrate Details:

7 gsm heat seal coated Plain Aluminum lidding foil of 20 microns

Anti-Counterfeit Features:

Micro-text (Visible when viewed under 10×)

Machine detectable Marker (Detectable by a machine)

UV Detectable Marker (Yellow & blue half tone glow under UV wavelength 200-400 nm)

Art-Work Details:

designing 2 color for text, micro text cum image/pattern+2 color for text/pattern having selective visibility with yellow & blue half tone which in combination results in green glow under UV light of wavelength 200-400 nm+1 design for over print coat

Plate Manufacturing:
(i) Plate 1: Exposure time—7 minutes Rear exposure and 22 minutes front exposure; Development time—12 minutes
(ii) Plate 2: Exposure time—6 minutes Rear exposure and 18 minutes front exposure; Development time—14 minutes
(iii) Plate 3: Exposure time—10 minutes Rear exposure and 20 minutes front exposure; Development time—12 minutes
(iv) Plate 4: Exposure time—10 minutes Rear exposure and 20 minutes front exposure; Development time—12 minutes
(v) Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—60 micron
Pressure for plate 4—60 micron
Pressure for plate 5—80 micron

Machine Run Parameters:
Speed: 200 mtrs./minute
Drying temperature between cylinders: 120° C.
Drying temperature in tunnel: 140° C.
Tension on rollers: 150 N/sq.m.
Temperature of Central Impression Drum: 32° C.

### Example No 56

Substrate Details:

7 gsm heat seal coated Plain Aluminum lidding foil of 20 microns

Anti-Counterfeit Features:

Micro-text (Visible when viewed under 10×)

Machine detectable Marker (Detectable by a machine)

UV Detectable Marker (Red glow under UV wavelength 200-400 nm)

Art-Work Details:

designing 3 color for text, micro text cum image/pattern+1 color for text/pattern having selective visibility with red glow under UV light of wavelength 200-400 nm+1 design for machine readable distinctive markers+1 design for over print coat

Plate Manufacturing:
(i) Plate 1: Exposure time—7 minutes Rear exposure and 22 minutes front exposure; Development time—11 minutes
(ii) Plate 2: Exposure time—8 minutes Rear exposure and 20 minutes front exposure; Development time—11 minutes
(iii) Plate 3: Exposure time—6 minutes Rear exposure and 18 minutes front exposure; Development time—14 minutes
(iv) Plate 4: Exposure time—10 minutes Rear exposure and 20 minutes front exposure; Development time—12 minutes
(v) Plate 5: Exposure time—8 minutes Rear exposure and 16 minutes front exposure; Development time—10 minutes
(vi) Plate 6: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—65 micron
Pressure for plate 3—60 micron
Pressure for plate 4—60 micron
Pressure for plate 5—50 micron
Pressure for plate 6—80 micron

Machine Run Parameters:
Speed: 250 mtrs./minute
Drying temperature between cylinders: 120° C.
Drying temperature in tunnel: 140° C.
Tension on rollers: 150 N/sq.m.
Temperature of Central Impression Drum: 32° C.

### Example No 57

Substrate Details:

7 gsm heat seal coated Plain Aluminum lidding foil of 20 microns

Anti-Counterfeit Features:

Micro-text (Visible when viewed under 10×)

Machine detectable Marker (Detectable by a machine)

UV Detectable Marker (blue glow under UV wavelength 200-400 nm)

Art-Work Details:

designing 2 color for text, micro text cum image/pattern+1 color for text/pattern having selective visibility with blue glow under UV light of wavelength 200-400 nm+1 design for machine readable distinctive markers+1 design for over print coat

Plate Manufacturing:
(i) Plate 1: Exposure time—7 minutes Rear exposure and 22 minutes front exposure; Development time—11 minutes
(ii) Plate 2: Exposure time—6 minutes Rear exposure and 18 minutes front exposure; Development time—14 minutes
(iii) Plate 3: Exposure time—5 minutes Rear exposure and 20 minutes front exposure; Development time—10 minutes
(iv) Plate 4: Exposure time—8 minutes Rear exposure and 16 minutes front exposure; Development time—10 minutes
(v) Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—80 micron
Pressure for plate 4—50 micron
Pressure for plate 5—80 micron

Machine Run Parameters:
Speed: 300 mtrs./minute
Drying temperature between cylinders: 120° C.
Drying temperature in tunnel: 140° C.
Tension on rollers: 150 N/sq.m.
Temperature of Central Impression Drum: 32° C.

### Example No 58

Substrate Details:

7 gsm heat seal coated Plain Aluminum lidding foil of 20 microns

Anti-Counterfeit Features:

Micro-text (Visible when viewed under 10×)

Machine detectable Marker (Detectable by a machine)

UV Detectable Marker (Yellow glow under UV wavelength 200-400 nm)

Art-Work Details:

designing 2 color for text, micro text cum image/pattern+1 color for text/pattern having selective visibility with yellow glow under UV light of wavelength 200-400 nm+1 design for machine readable distinctive markers+1 design for over print coat

Plate Manufacturing:
i. Plate 1: Exposure time—7 minutes Rear exposure and 22 minutes front exposure; Development time—11 minutes
ii. Plate 2: Exposure time—6 minutes Rear exposure and 18 minutes front exposure; Development time—14 minutes
iii. Plate 3: Exposure time—10 minutes Rear exposure and 20 minutes front exposure; Development time—12 minutes
iv. Plate 4: Exposure time—8 minutes Rear exposure and 16 minutes front exposure; Development time—10 minutes
v. Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—60 micron
Pressure for plate 4—50 micron
Pressure for plate 5—80 micron

Machine Run Parameters:
Speed: 200 mtrs./minute
Drying temperature between cylinders: 120° C.
Drying temperature in tunnel: 140° C.
Tension on rollers: 150 N/sq.m.
Temperature of Central Impression Drum: 32° C.

### Example No 59

Substrate Details:

7 gsm heat seal coated Plain Aluminum lidding foil of 20 microns

Anti-Counterfeit Features:

Micro-text (Visible when viewed under 10×)

Machine detectable Marker (Detectable by a machine)

UV Detectable Marker (Yellow & blue half tone glow under UV wavelength 200-400 nm)

Art-Work Details:

designing 2 color for text, micro text cum image/pattern+2 color for text/pattern having selective visibility with yellow, red & half tone orange glow under UV light of wavelength 200-400 nm+1 design for machine readable distinctive markers+1 design for over print coat

Plate Manufacturing:
(i) Plate 1: Exposure time—7 minutes Rear exposure and 22 minutes front exposure; Development time—11 minutes
(ii) Plate 2: Exposure time—6 minutes Rear exposure and 18 minutes front exposure; Development time—14 minutes
(iii) Plate 3: Exposure time—10 minutes Rear exposure and 20 minutes front exposure; Development time—12 minutes
(iv) Plate 4: Exposure time—8 minutes Rear exposure and 16 minutes front exposure; Development time—10 minutes
(v) Plate 5: Exposure time—5 minutes Rear exposure and 15 minutes front exposure; Development time—15 minutes
(vi) Plate 6: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—80 micron
Pressure for plate 4—80 micron
Pressure for plate 5—80 micron
Pressure for plate 6—80 micron

Machine Run Parameters:
Speed: 250 mtrs./minute
Drying temperature between cylinders: 120° C.
Drying temperature in tunnel: 140° C.
Tension on rollers: 150 N/sq.m.
Temperature of Central Impression Drum: 32° C.

### Example No 60

Substrate Details:

7 gsm heat seal coated Plain Aluminum lidding foil of 20 microns

Anti-Counterfeit Features:

Micro-text (Visible when viewed under 10×)

Machine detectable Marker (Detectable by a machine)

IR Detectable Marker (Yellow glow under IR wavelength 100-300 micro m)

Art-Work Details:

designing 2 color for text, micro text cum image/pattern+1 color for text/pattern having selective visibility with yellow glow under IR light of wavelength 100-300 micro m+1 design for machine readable distinctive markers+1 design for over print coat

Plate Manufacturing:
(i) Plate 1: Exposure time—7 minutes Rear exposure and 22 minutes front exposure; Development time—11 minutes
(ii) Plate 2: Exposure time—6 minutes Rear exposure and 18 minutes front exposure; Development time—14 minutes
(iii) Plate 3: Exposure time—10 minutes Rear exposure and 20 minutes front exposure; Development time—12 minutes
(iv) Plate 4: Exposure time—8 minutes Rear exposure and 16 minutes front exposure; Development time—10 minutes
(v) Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—60 micron
Pressure for plate 4—50 micron
Pressure for plate 5—80 micron

Machine Run Parameters:
Speed: 200 mtrs./minute
Drying temperature between cylinders: 120° C.
Drying temperature in tunnel: 140° C.
Tension on rollers: 150 N/sq.m.
Temperature of Central Impression Drum: 32° C.

### Example No 61

Substrate Details:

5 gsm heat seal coated Plain Aluminum lidding foil of 18 microns

Anti-Counterfeit Features:

Micro-text (Visible when viewed under 10×)

Machine detectable Marker (Detectable by a machine)

UV Detectable Marker (Yellow glow under UV wavelength 200-400 nm)

Art-Work Details:

designing 2 color for text, micro text cum image/pattern+1 color for text/pattern having selective visibility with yellow glow under UV light of wavelength 200-400 nm+1 design for machine readable distinctive markers+1 design for over print coat

Plate Manufacturing:
(i) Plate 1: Exposure time—7 minutes Rear exposure and 22 minutes front exposure; Development time—11 minutes
(ii) Plate 2: Exposure time—6 minutes Rear exposure and 18 minutes front exposure; Development time—14 minutes
(iii) Plate 3: Exposure time—10 minutes Rear exposure and 20 minutes front exposure; Development time—12 minutes
(iv) Plate 4: Exposure time—8 minutes Rear exposure and 16 minutes front exposure; Development time—10 minutes
(v) Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—60 micron
Pressure for plate 4—50 micron
Pressure for plate 5—80 micron

Machine Run Parameters:
Speed: 200 mtrs./minute
Drying temperature between cylinders: 120° C.
Drying temperature in tunnel: 140° C.
Tension on rollers: 150 N/sq.m.
Temperature of Central Impression Drum: 32° C.

### Example No 62

Substrate Details:

5 gsm heat seal coated Plain Aluminum lidding foil of 18 microns

Anti-Counterfeit Features:

Micro-text (Visible when viewed under 10×)

Machine detectable Marker (Detectable by a machine)

UV Detectable Marker (Yellow & green half tone glow under UV wavelength 200-400 nm)

Art-Work Details:

designing 2 color for text, micro text cum image/pattern+2 color for text/pattern having selective visibility with yellow & blue half tone which in combination results in green glow under UV light of wavelength 200-400 nm+1 design for over print coat

Plate Manufacturing:
(i) Plate 1: Exposure time—7 minutes Rear exposure and 22 minutes front exposure; Development time—12 minutes
(ii) Plate 2: Exposure time—6 minutes Rear exposure and 18 minutes front exposure; Development time—14 minutes
(iii) Plate 3: Exposure time—10 minutes Rear exposure and 20 minutes front exposure; Development time—12 minutes
(iv) Plate 4: Exposure time—10 minutes Rear exposure and 20 minutes front exposure; Development time—12 minutes
(v) Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—60 micron
Pressure for plate 4—60 micron
Pressure for plate 5—80 micron

Machine Run Parameters:
Speed: 200 mtrs./minute
Drying temperature between cylinders: 120° C.
Drying temperature in tunnel: 140° C.
Tension on rollers: 150 N/sq.m.
Temperature of Central Impression Drum: 32° C.

### Example No 63

Substrate Details:

5 gsm heat seal coated Plain Aluminum lidding foil of 18 microns

Anti-Counterfeit Features:

Micro-text (Visible when viewed under 10×)

Machine detectable Marker (Detectable by a machine)

UV Detectable Marker (Red glow under UV wavelength 200-400 nm)

Art-Work Details:

designing 3 color for text, micro text cum image/pattern+1 color for text/pattern having selective visibility with red glow under UV light of wavelength 200-400 nm+1 design for machine readable distinctive markers+1 design for over print coat

Plate Manufacturing:
(i) Plate 1: Exposure time—7 minutes Rear exposure and 22 minutes front exposure; Development time—11 minutes
(ii) Plate 2: Exposure time—8 minutes Rear exposure and 20 minutes front exposure; Development time—11 minutes

(iii) Plate 3: Exposure time—6 minutes Rear exposure and 18 minutes front exposure; Development time—14 minutes

(iv) Plate 4: Exposure time—10 minutes Rear exposure and 20 minutes front exposure; Development time—12 minutes

(v) Plate 5: Exposure time—8 minutes Rear exposure and 16 minutes front exposure; Development time—10 minutes
(vi) Plate 6: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—65 micron
Pressure for plate 3—60 micron
Pressure for plate 4—60 micron
Pressure for plate 5—150 micron
Pressure for plate 6—180 micron

Machine Run Parameters:
Speed: 250 mtrs./minute
Drying temperature between cylinders: 120° C.
Drying temperature in tunnel: 140° C.
Tension on rollers: 150 N/sq.m.
Temperature of Central Impression Drum: 32° C.

### Example No 64

Substrate Details:

5 gsm heat seal coated Plain Aluminum lidding foil of 18 microns

Anti-Counterfeit Features:

Micro-text (Visible when viewed under 10×)

Machine detectable Marker (Detectable by a machine)

UV Detectable Marker (blue glow under UV wavelength 200-400 nm)

Art-Work Details:

designing 2 color for text, micro text cum image/pattern+1 color for text/pattern having selective visibility with blue glow under UV light of wavelength 200-400 nm+1 design for machine readable distinctive markers+1 design for over print coat

Plate Manufacturing:
i. Plate 1: Exposure time—7 minutes Rear exposure and 22 minutes front exposure; Development time—11 minutes
ii. Plate 2: Exposure time—6 minutes Rear exposure and 18 minutes front exposure; Development time—14 minutes
iii. Plate 3: Exposure time—10 minutes Rear exposure and 20 minutes front exposure; Development time—12 minutes
iv. Plate 4: Exposure time—8 minutes Rear exposure and 16 minutes front exposure; Development time—10 minutes
v. Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—80 micron
Pressure for plate 4—50 micron
Pressure for plate 5—80 micron

Machine Run Parameters:
Speed: 300 mtrs./minute
Drying temperature between cylinders: 120° C.
Drying temperature in tunnel: 140° C.
Tension on rollers: 150 N/sq.m.
Temperature of Central Impression Drum: 32° C.

### Example No 65

Substrate Details:

5 gsm heat seal coated Plain Aluminum lidding foil of 18 microns

Anti-Counterfeit Features:

Micro-text (Visible when viewed under 10×)

Machine detectable Marker (Detectable by a machine)

UV Detectable Marker (Yellow glow under UV wavelength 200-400 nm)

Art-Work Details:

designing 2 color for text, micro text cum image/pattern+1 color for text/pattern having selective visibility with yellow glow under UV light of wavelength 200-400 nm+1 design for machine readable distinctive markers+1 design for over print coat

Plate Manufacturing:
i. Plate 1: Exposure time—7 minutes Rear exposure and 22 minutes front exposure; Development time—11 minutes
ii. Plate 2: Exposure time—6 minutes Rear exposure and 18 minutes front exposure; Development time—14 minutes
iii. Plate 3: Exposure time—10 minutes Rear exposure and 20 minutes front exposure; Development time—12 minutes
iv. Plate 4: Exposure time—8 minutes Rear exposure and 16 minutes front exposure; Development time—10 minutes
v. Plate 5: Exposure time—5 minutes Rear exposure and 15 minutes front exposure; Development time—15 minutes

Print Process:

Ink preparation and ink loading into reservoirs with close loop circulation system

Measured viscosity of inks: 32 s

Mounted plates on cylinders & adjusted pressure
Pressure for plate 1—55 micron
Pressure for plate 2—105 micron
Pressure for plate 3—60 micron
Pressure for plate 4—50 micron
Pressure for plate 5—80 micron

Machine Run Parameters:
Speed: 200 mtrs./minute
Drying temperature between cylinders: 120° C.
Drying temperature in tunnel: 140° C.
Tension on rollers: 150 N/sq.m.
Temperature of Central Impression Drum: 32° C.

The printed foil as prepared in examples 33-65 were tested for the print related functional and visual parameters as provided in the example 1 to 5.

All test results were satisfactory and conformed to the specifications as specified in test methods.

Further the printed foil was tested for the following physical & chemical parameters
1. Thickness
2. Foil, coating and printing GSM
3. Pinholes
4. Elongation
5. Tensile Strength
6. Heat sealability
7. Odor absence
8. Fume liberation
9. leak test after blister formation
10. Volatile content
11. Toxicity

All above performed tests were conducted using standard/in-house specified test methods. Test results were satisfactory and complied to the requirements specified in the test methods.

Technical Advancement:

The present invention provides based printed packaging foils, films and laminates providing discernible identity for authentication and anti-counterfeit measures for convenience packs and process for manufacturing the same, as described in the present invention has several technical advantages including but not limited to the realization of

The present invention provides a multilayered anti-counterfeit solution that is applicable for a wide range of substrates. It is not possible to reproduce the packaging material of the present invention using any of the known print technologies.

The present invention provides a process for manufacture of a packaging material having discernible identity for authentication and anti-counterfeit measures for convenience packs provided with ultra thin specialty barrier coating which ensures complete plugging of micro crack/pinholes.

The packaging material of the present invention allows the manufacture of convenience packs with excellent uniformity at significantly lower grammage of the sealing lacquers/coatings resulting in significantly higher productivity and lower wastages and no packs with unsealed portions due to uncoated patches;

The packaging material of the present invention is suitable for manufacturing convenience packs with excellent readability of even the fine printed text matter and assurance of no damage and/or contamination to the foil during printing resulting in micro cracks/pinholes and/or coatings/inks/lacquers contaminated with metal during process due to sophisticated kiss-print technique, and use of specialty polymeric plates for printing/lacquering/coating processes; and

The process of the present invention provides allows the manufacture of the packaging material having discernible identity for authentication and anti-counterfeit measures for convenience packs with ultra thin deposition of lacquer/ink/coatings resulting in no entrapment of solvent and therefore completely cured image/text/pattern which has significantly higher resistance to scuff/abrasion during packaging operations, transit and storage.

While certain embodiments of the inventions have been described, these embodiments have been presented by way of example only, and are not intended to limit the scope of the inventions. Variations or modifications to the design and construction of this invention, within the scope of the invention, may occur to those skilled in the art upon reviewing the disclosure herein. Such variations or modifications are well within the spirit of this invention. The accompanying claims and their equivalents are intended to cover such forms or modifications as would fall within the scope and spirit of the invention.

The numerical values given for various physical parameters, dimensions and quantities are only approximate values and it is envisaged that the values higher than the numerical value assigned to the physical parameters, dimensions and quantities fall within the scope of the invention and the claims unless there is a statement in the specification to the contrary.

1. A packaging material comprising a plurality of layers, said material having discernible indicia for authentication characterized by the presence of at least one predetermined anti-counterfeit feature at, at least one predetermined location in at least one predetermined visible layer.

2. A packaging material as claimed in claim 1, wherein the anti-counterfeit feature is in a form selected from the group consisting of a geometric pattern, a non-geometric pattern, a graphic matter, miniature size textual matter, ink which becomes visible in U.V. light, ink which becomes visible in Infra Red, a color scheme, nano-particle based signature marker, machine readable marker and a combination thereof.

3. A packaging material as claimed in claim 1, wherein the feature is visible to the naked eye.

4. A packaging material as claimed in claim 1, wherein the feature is selectively visible in a predetermined manner.

5. A packaging material as claimed in claim 1, wherein the feature is recognizable under predetermined wavelength spectrum of ultra-violet light.

6. A packaging material as claimed in claim 1, wherein the feature is in a machine readable form.

7. A packaging material as claimed in claim 1, wherein the feature is further characterized by its concentration at said predetermined location.

8. A packaging material as claimed in claim 1, wherein the visible layer is a metallic layer with a thickness of about 5 microns to about 200 microns.

9. A packaging material as claimed in claim 1, wherein the visible layer is an aluminum foil with a thickness of about 15 microns to about 80 microns.

10. A packaging material as claimed in claim 1, wherein the visible layer is selected from the group consisting of thermoformable polymer film, thermoformable polymer laminate, heat sealable BOPP film, heat sealable BOPP laminate, heat seal lacquer coated glassine paper, aluminum based cold formable foil, aluminum based laminated strip foil and heat seal coated aluminum foil.

11. A packaging material as claimed in claim 1, wherein the packaging material is selected from the group consisting of a thermoformed blister containing material and a cold formed blister containing material.

12. A packaging material as claimed in claim 1, that complies with the requirements for packaging of pharmaceuticals and food-grade items.

13. A process for manufacture of a packaging material of claim 1, comprising the following steps:
selecting an artwork input to be used in printing of a substrate;
selecting a substrate;
creating a scheme for incorporation of a predetermined anti-counterfeit feature on the substrate;
making a print plan with a set of predetermined print parameters using the scheme;
storing the scheme and the print plan in a database;
incorporating the feature on the substrate by a combination of print means and non-print means, in a sequential manner, using said scheme and print plan to obtain a printed substrate with discernible indicia for authentication; and
preparing the packaging material using the printed substrate as one of its visible layer.

14. A packaging material as claimed in claim 13, wherein the anti-counterfeit feature is in a form selected from the group consisting of a geometric pattern, a non-geometric pattern, a graphic matter, miniature size textual matter, ink which becomes visible in U.V. light, ink which becomes visible in Infra red, a color scheme, nano-particle based signature marker, machine readable marker and a combination thereof.

15. A packaging material as claimed in claim 13, wherein the feature is incorporated is incorporated on the substrate by print means with a predetermined concentration at a predetermined location.

16. A process as claimed in claim 11, wherein the scheme comprises at least one predetermined parameter selected from the group consisting of shape, size, color-shade and location of the feature in the packaging material.

17. A process as claimed in claim 11, wherein the print parameter is at least one selected from the group consisting of configuration of the anilox printer ranging between 70 to 340 lines per centimeter, speed within a range of about 60 meters per minute to about 350 meters per minute, the drying temperature between cylinders within a range of about 80° C. to about 130° C.; the drying temperature in tunnel within a range of about 120° C. to 160° C.; the tension on the rollers ranging between 120 to about 300 N/sq.m; plate pressure in the range of about 30 to 150 microns and the temperature of central impression drum ranging between 20 to 35° C.

18. A process as claimed in claim 11, wherein the print means is a flexographic printing machine and the non-print means is at least one selected from the group consisting of embossing means, coating means and lacquering means.

19. A process as claimed in claim 11, wherein the substrate is selected from the group consisting of thermoformable polymer film, thermoformable polymer laminate, heat sealable BOPP film, heat sealable BOPP laminate, heat seal lacquer coated glassine paper, aluminum based cold formable foil, aluminum based laminated strip foil and heat seal coated aluminum foil.
